(19) United States
(12) Patent Application Publication
(10) Pub. No.: US 2025/0245303 A1
(43) Pub. Date: Jul. 31, 2025

(54) PERIPHERAL DEVICE-BASED MANAGEMENT OF USER SPACE PROCESS CREDENTIALS

(71) Applicant: HEWLETT PACKARD ENTERPRISE DEVELOPMENT LP, Spring, TX (US)

(72) Inventors: Geoffrey Ndu, Bristol (GB); Theofrastos Koulouris, Bristol (GB); Nigel J. Edwards, Bristol (GB)

(21) Appl. No.: 18/426,821

(22) Filed: Jan. 30, 2024

(51) Int. Cl. G06F 21/31; G06F 21/64; G06F 21/85

(52) U.S. Cl. CPC G06F 21/31; G06F 21/64; G06F 21/85

(57) ABSTRACT

A technique includes communicating with an operating system-based kernel of a host and receiving, from an operating system-based kernel, an integrity measurement of a user space process of the host. The technique includes verifying, based on the integrity measurement, whether a first state of the user space process corresponds to an expected state for the user space process. The technique includes, responsive to verification that the first state corresponds to the expected state, communicating with the kernel to provision an authentication credential for the user space process to allow the user space process to use a service provided by the peripheral device.

### BACKGROUND

A computer platform may be subject to a security attack in which a malevolent actor seeks to access information that is stored on the computer platform or harm components of the computer platform. A computer platform may have various defenses for purposes of preventing security attacks or at least mitigating the degree of harm inflicted by security attacks.

### BRIEF DESCRIPTION OF THE DRAWINGS

FIG. 1 is a schematic diagram of a computer platform having a peripheral device and an infrastructure to manage credentials that are used by user space processes to access the peripheral device according to an example implementation.

FIGS. 2 and 3 are sequence flow diagrams depicting techniques to provision credentials for user space processes according to example implementations.

FIG. 4 is a sequence flow diagram depicting a technique to monitor the trustworthiness of a user space process and revoke the credential(s) of the user space process responsive to a determination that the user space process is no longer trustworthy according to an example implementation.

FIGS. 5 and 6 are sequence flow diagram depicting techniques to monitor the integrity of an infrastructure that manages credentials of user space processes according example implementations.

FIG. 7 is a sequence flow diagram depicting a technique to set up a communication channel between a user space process and a peripheral device according to an example implementation.

FIG. 8 is an illustration of a non-transitory storage medium that stores machine-readable instructions that, when executed by a peripheral device, cause the peripheral device to provision a user space process authentication credential according to an example implementation.

FIG. 9 is a schematic diagram of a computer platform having a peripheral device to authenticate a user space process based on a credential and manage the credential according to an example implementation.

FIG. 10 is a flow diagram depicting a technique used by a peripheral device to manage a user space process credential according to an example implementation.

### DETAILED DESCRIPTION

A computer platform (e.g., a blade server or a rack server) may include an operating system-affiliated host and peripheral devices that support the host. An application or service of the host may use one or multiple services that are provided by a peripheral device. A baseboard management controller is an example of such a peripheral device. For example, a host service may interact with one or multiple management services that are provided by a baseboard management controller for such purposes as reporting operating system event information to the baseboard management controller or receiving logs (e.g., event logs, status logs or other logs) that are maintained by the baseboard management controller. In another example, a host-based smart update manager (SUM) may interact with one or multiple management services that are provided by a baseboard management controller for such purposes as installing and updating drivers, firmware and system software of the computer platform. A host-based application or service has a corresponding executing instance, which is called a “user space process” herein.

A peripheral device may be configured to operate in one of potentially multiple security modes of operation. The security modes of operation may correspond to different levels of security for the peripheral device. Depending on the particular security mode, the peripheral device may or may not impose host authentication. In this context, the peripheral device imposing “host authentication” generally refers to a host entity's access to the peripheral device being contingent on the peripheral device verifying the identity of the host entity and trusting the verified identity. In an example, a peripheral device may be configured to operate in a relatively lower security mode of operation (e.g., a production mode of operation) in which the peripheral device trusts all user space processes and correspondingly, does not impose host authentication. In another example, a peripheral device may be configured to operate in a relatively higher security mode of operation in which the peripheral device imposes host authentication.

Host authentication may be implemented in a number of different ways. In one approach, host authentication may involve the user space process prompting a human user for credentials, which the user space process then provides to the peripheral device. For example, host authentication may involve a user space process prompting a human user for a user name (or “username”) and a password. In this manner, user accounts may be pre-authorized for a particular peripheral device, and the peripheral device may, as part of host authentication, verify whether the user name and password that are provided by a user space process correspond to an authorized account. With this approach, a user may be prompted to enter credentials for each session between a user space process and a peripheral device. Among the potential challenges with such an approach, human involvement with host authentication may be impractical for some computing environments (remote computing environments, large scale computing environments, data center-based computing environments, as well as other computing environments).

In another approach to host authentication, a peripheral device may automatically assign, without human intervention, credentials to user space processes. However, with this approach, the peripheral device may potentially assign credentials to user space processes that have not been approved for the computer platform or have not been approved for use with the peripheral device. Moreover, even with restricting credential assignment to pre-approved user space processes, there may be no mechanism in place to revoke issued credentials for a user space process that has been subject to tampering. The lack of such a mechanism may pose security concerns for a computer platform, especially if the peripheral device is a component (e.g., a baseboard management controller) that provides security services for the computer platform.

In accordance with example implementations, a computer platform includes a host credential management infrastructure for purposes of managing credentials that allow host-based user space processes to access resources of a peripheral device. The host credential management infrastructure includes a verification agent of the peripheral device and an operating system kernel-based helper agent of the host.

A user space process, in accordance with example implementations, may submit a request to the helper agent to receive credentials for accessing the peripheral device. As further described herein, the helper agent, responsive to the request, notifies the verification agent, and the verification agent applies a particular trust model for purposes of determining whether the requesting user space process is trustworthy. As further described herein, the verification agent, in accordance with example implementations, may base the trustworthiness determination on integrity measurements that are gathered by the helper agent responsive to the request. If the verification agent determines that the requesting user space process is trustworthy, then the verification agent provisions credentials for the user space process. Moreover, in accordance with example implementations, the verification agent may continually reevaluate the trustworthiness of the user space process. In this manner, the verification agent may, as a result of a reevaluation of a user space process, revoke the user space process' credentials responsive to determining that the user space process is no longer trustworthy. In an example, the verification agent may revoke the credentials assigned to a user space process responsive to determining that the integrity of the user space process has been compromised.

One or multiple credentials may be assigned to a user space process, depending on the specific way in which the host authentication is implemented. Stated differently, depending on the type of host authentication, a user space process may access the peripheral device using a single credential or using multiple credentials.

In an example of single credential-based host authentication, the verification agent may assign a token to a user space process. The user space process may provide the token to the peripheral device as a credential, which allows the peripheral device to authenticate the user space process. In another example, the verification agent may assign a randomly-generated or pseudorandomly-generated number to a user space process. The user space process may provide the number to the peripheral device as a credential, which allows the peripheral device to authenticate the user space process. In another example, the verification agent may assign a secret to the peripheral device. The secret may be shared with the peripheral device, and as part of the host authentication, the user space process may demonstrate, to the peripheral device, possession of the shared secret.

Multiple credential-based host authentication may be implemented in a number of different ways. In an example, the verification agent may assign an asymmetric cryptographic key pair to a user space process, and host authentication may include the user space process demonstrating, to the peripheral device, possession of the private key of the asymmetric key pair. In another example, the verification agent may assign a user name and a password to a user space process, and host authentication may include the user space process providing the user name and the password to the peripheral device.

Regardless of how host authentication is implemented, the credential(s) assigned to a user space process allow the user space process to access one or multiple resources (e.g., application programming interfaces (APIs), services, registers and memory and other resources) of the peripheral device. The level of access may depend on the set of access privileges, or permissions, that are assigned to the credential(s).

In accordance with example implementations, a user space process may request credential(s) by submitting a registration request to the helper agent. In an example, a user space process may make an API call, a registration request, to a registration API of the helper agent. The registration request initiates a registration phase. The registration phase corresponds to a sequence of actions that are taken by the host credential management infrastructure for purposes of determining whether the user space process is trustworthy, and the registration phase concludes with credential(s) being provisioned for the user space process if the user space process is determined to be trustworthy. Otherwise, if the host credential management infrastructure determines that the user space process is untrustworthy, then the registration phase concludes with the registration request being denied.

In accordance with example implementations, in connection with the registration phase, the helper agent measures the credential-requesting user space process to determine one of multiple initial runtime integrity measurements of the user space process. In an example of an initial runtime integrity measurement, the helper agent may determine a hash, or digest (called a “runtime digest” herein) from in-memory content that corresponds to the user space process and is not expected to vary during runtime, as further described herein. In another example, an initial runtime integrity measurement may be a runtime attribute of the user space process, which is not a digest, or hash. The helper agent sends data representing the initial runtime integrity measurements to the verification agent. More specifically, in accordance with example implementations, the helper agent, as part of the registration phase, sends, to the verification agent, a report (called the “initial report” herein) that includes data that represents the initial runtime digest and further includes metadata that describes attributes of the user space process.

The verification agent may apply one out of many possible trust models for purposes of determining whether a credential-requesting user space process is trustworthy. In an example, the verification agent may apply what is referred to herein as an “expected state trust model.” More specifically, in accordance with some implementations, the verification agent determines whether a user space process has an expected state (and therefore, whether the user space process can be trusted) based on the initial runtime integrity measurements that are provided by the initial report that is sent by the helper agent. This evaluation may include the verification agent comparing the initial runtime integrity measurements digest to expected integrity measurements for the user space process for purposes of determining whether the initial runtime integrity measurements are expected. In an example, the peripheral device may be provisioned, prior to runtime, with a signed manifest file. The manifest file contains a list of expected runtime digests that correspond to respective user space processes that have been approved for use with the peripheral device. Moreover, the manifest file may associate each expected runtime digest with a collection of additional non-digest expected runtime integrity measurements. If the initial runtime digest does not correspond to any of the expected digests of the manifest file, then, in accordance with example implementations, the verification agent denies the registration request and does not provision any credential(s) for the user space process.

The verification agent's evaluation of whether a user space process is trustworthy may consider one or multiple criteria in addition to whether the initial runtime digest matches an expected digest. For example, the verification agent may also consider whether any of the attributes that are represented by the metadata of the initial report are unexpected. In an example, an attribute may be a process path for the user space process. In another example, attributes may be command-related characteristics of the user space process, such as the name of an executable file that corresponds to the user space process and one or multiple parameters passed to the user space process. In another example, an attribute may be an extent of a memory segment corresponding to the user space process. In another example, an attribute may be an environment variable. Depending on the particular implementation, some, none, or all of a set of expected attributes for a user space process may be contained in the manifest file or in another dataset or file provisioned for the peripheral device prior to runtime.

In another example, for purposes of evaluating whether a user space process is trustworthy, the verification agent may rely on a trust model other than the above-described expected state trust model. For example, the verification agent may apply a trust on first use (TOFU) trust model in which the verification agent assumes that a particular user space process registering for the first time (e.g., the first time after the boot or reset of the computer platform) is trustworthy. The TOFU trust model, in accordance with example implementations, assumes appropriate conditions exist to trust user space processes on first use. In an example, these conditions may be assumed to exist in an initial runtime environment of the computer platform after the computer platform boots. As a more specific example, the computer platform may undergo a secure and measured boot so that at the conclusion of the boot, all user space processes may initially be assumed to be trustworthy (e.g., initially assumed to be trustworthy on first use).

The verification agent may uniquely identify a particular user space process based on the metadata that is contained in the corresponding initial report that is provided by the helper agent. In examples, the verification agent may uniquely identify a user space process by one or multiple of the name of the corresponding executable file, command parameters, a process ID, a process path or other identifying characteristics associated with the user space process.

Regardless of the particular trust model and how the verification agent evaluates the trustworthiness of a user space process, if the verification agent determines that the user space process is trustworthy, then the verification agent provisions credential(s) for the user space process. Provisioning the credential(s) may include the verification agent generating the credential(s) and the verification agent assigning the credential(s) to the user space process. Moreover, provisioning the credential(s) may further include the verification agent sending the credential(s) to the helper agent, and the helper agent providing the credential(s) to the user space process to conclude the registration phase. A user space process that has been provisioned credential(s) is referred to herein as a “registered” user space process.

The verification agent, in accordance with example implementations, continually re-evaluates the trustworthiness of each registered user space process. The verification agent couples these re-valuations with the authority to remove, or revoke, the credential(s) of a registered user space process should the user space process be determined to be untrustworthy. More specifically, in accordance with some implementations, the verification agent may, for a particular registered user space process, regularly (e.g., at times pursuant to a schedule, such as a periodic schedule) send re-verification requests to the helper agent.

A re-verification request prompts the helper agent to remeasure a registered user space process to derive a corresponding collection of current integrity measurements of the user space process. This collection includes a current runtime digest and additional current non-digest integrity measurements (also called “attributes” herein). The helper agent sends a report to the verification agent containing data representing the current runtime digest and also containing metadata that describe the current attributes. The verification agent has a collection of expected integrity measurements for the registered user space process, whether from a manifest file or, for the TOFU trust model, the initial report that is sent by the helper agent. The verification agent determines, based on a comparison of the current runtime integrity measurements with the expected integrity measurements, whether the registered user space process is still considered trustworthy. In accordance with example implementations, the verification agent revokes the credential(s) of a registered user space process responsive to the verification agent determining, as a result of the re-verification, that the user space process is no longer considered trustworthy.

The verification agent, in accordance with example implementations, continually monitors the host credential management infrastructure for purposes of determining whether the integrity of the host credential management infrastructure has been compromised. If the verification agent determines that the integrity of the host credential management infrastructure has been compromised, then, in accordance with example implementations, the verification agent may initiate one or multiple responsive actions. In an example, responsive to determining that the integrity of the host credential management infrastructure has been compromised, the verification agent may revoke all of the registered user space process credentials, among other possible responsive actions.

The verification agent may monitor the integrity of the host credential management infrastructure in any of a number of different ways. In an example, the verification agent may use the re-verification requests as a mechanism to monitor the integrity of the host credential management infrastructure. For example, the verification agent may determine that the integrity of the host credential management infrastructure has been compromised if a response to a particular re-verification request not being received within an expected time period.

In another example of a way to monitor the integrity of the host credential management infrastructure, the verification agent may send aliveness nonces to the helper agent pursuant to a schedule (e.g., send the aliveness nonces at times according to a periodic schedule). In examples, an aliveness nonce may be a randomly-generated number or a pseudorandomly-generated number. The verification agent expects to observe a certain response to the sending of an aliveness nonce. In an example, the verification agent may expect the helper agent to apply a certain function (e.g., add a predetermined number) to the aliveness nonce to generate a response nonce, which the helper agent sends back to the verification agent. In an example, the verification agent may determine that the integrity of the host credential management infrastructure has been compromised responsive to the verification agent not receiving a response to an aliveness nonce within an expected time period. In another example, the verification agent may determine that the integrity of the host credential management infrastructure has been compromised responsive to the verification agent receiving an unexpected response nonce.

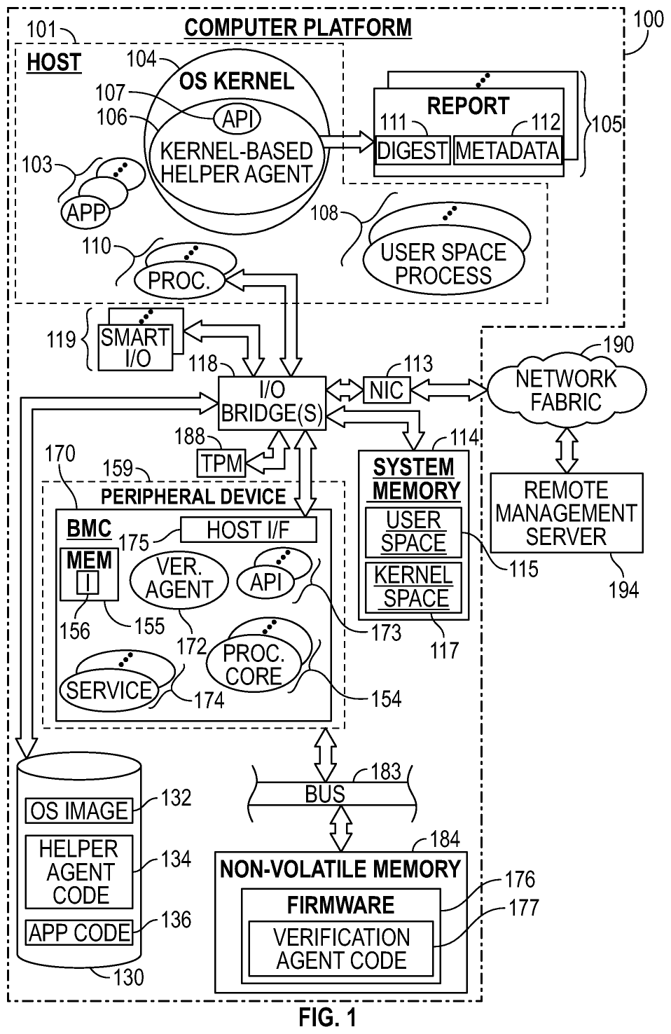

Referring to FIG. 1, as a more specific example, in accordance with some implementations, a computer platform 100 includes a host 101 and one or multiple peripheral devices, such as an example peripheral device 159. In the context that is used herein, a “host” refers to a collection of resources of a computer platform 100, which are associated with a primary function of supporting an operating system kernel and processes that are managed by the operating system kernel. For the example implementation that is depicted in FIG. 1, the host 101 includes one or multiple hardware processor(s) 110 and a system memory 114, which support an operating system kernel 104, user space processes 108 and kernel space processes.

In an example, a hardware processor 110 may include one or multiple processing cores, such as central processing unit (CPU) processing cores that are contained in one or multiple CPU packages (or “sockets”). The system memory 114 and other memories discussed herein are non-transitory storage media that may be formed from semiconductor storage devices, memristor-based storage devices, magnetic storage devices, phase change memory devices, a combination of devices of one or more of these storage technologies, and so forth. The system memory 114 may represent a collection of volatile memory devices and non-volatile memory devices, in accordance with example implementations.

In accordance with example implementations, the memory locations of the system memory 114 include locations that correspond to a user space 115 and locations that correspond to a kernel space 117. “Kernel space,” in the context that is used herein, refers to the memory space of the computer platform 100 in which instructions corresponding to an operating system kernel, such as operating system kernel 104, are stored and execute. A LINUX kernel and a WINDOWS NT kernel are examples of operating system kernels. “User space,” in the context that is used herein, refers to the memory space of the computer platform 100, which is used by non-operating system kernel processes, called “user space processes 108” herein. In an example, a user space process 108 may correspond to an application 103. In general, an “application” generally refers to a program that is associated with a user environment (e.g., a graphical user interface (GUI) or other environment to facilitate user interaction). In another example, a user space process 108 may correspond to a service. In general, a “service” refers to a program that is primarily directed to tasks (e.g., background tasks, tasks to service applications, and other tasks) that do not involve user interaction. In another example, given user space process 108 may correspond to program that is a combination of an application and a service.

System calls made through a system call interface allows a user space process 108 to enter the kernel space 117 to perform certain operations (e.g., accessing files, sending or receiving packets over the network or communicating data to the user). When a user space process 108 enters kernel space 117 via a system call, the user space process 108 may get suspended and the corresponding thread given to another process. The user space portion of a program (e.g., an application 103 or service), may vary from one program to another.

In the context that is used herein, a “process,” such as a user space process 108, refers to an instance of an executing program. A given user space process 108 may be single-threaded (i.e., correspond to a single thread) or multithreaded (i.e., correspond to multiple threads), where a “thread” refers to a unit of executable program instructions. For example, multiple threads may be executed in parallel by multiple processing cores of the computer platform 100 to perform a particular task or set of tasks for the computer platform 100.

The architecture that is depicted in FIG. 1 is just one example of a number of different potential architectures for the computer platform 100, in accordance with the many possible implementations. In general, regardless of its particular architecture, a “computer platform” refers to a processor-based electronic device, which has an operating system that has an associated kernel space and user space. As examples, the computer platform 100 may be a standalone server; a rack-mounted server module; an edge processing system; a rack-mounted module; a blade server; a chassis management controller; a client; a thin client; a desktop computer; a portable computer; a laptop computer; a notebook computer; a tablet computer; a smartphone; a network switch; a gateway device; a wearable computer; or another processor-based electronic device.

A “peripheral device,” in the context that is used herein, refers to a component of a computer platform, other than the platform's host, which provides one or multiple auxiliary functions to support the host. For the example implementation that is depicted in FIG. 1, the peripheral device 159 is a baseboard management controller 170. The baseboard management controller 170 provides one or multiple management services 174 that are used by one or multiple user space processes 108. For this purpose, the baseboard management controller 170 includes one or multiple APIs 173. In an example, a user space process 108 may correspond to a host-based service that uses one or multiple services 174 of the baseboard management controller 170 for such purposes as reporting operating system event information to the baseboard management controller 170 or acquiring logs (e.g., fault detection logs, device health logs, intrusion detection logs, or other management-related logs) from the baseboard management controller 170. In another example, a user space process 108 may correspond to a smart update manager (SUM) that uses one or multiple services 174 of the baseboard management controller 170 for such purposes as installing and updating drivers, firmware and system software on the computer platform 100.

In the context that is used herein, an application programming interface, or “API,” refers to a collection of software components, which collectively provide one or multiple functions, operations or actions. As described herein, an API call is directed to invoking one or multiple functions, operations or actions of a particular API. The API may provide a response (an “API response”) to an API call.

The baseboard management controller 170 is an example of a peripheral device 159 that has a security mode of operation (e.g., one of many security modes or the sole security mode) that restricts access to the services that are provided by the peripheral device 159 by imposing host authentication. For the example implementation that is depicted in FIG. 1, the baseboard management controller 170 includes a host interface 175 (or “host communication interface 175”) that, for a particular security mode of operation, is locked down by the baseboard management controller 170 so that none of the services 174 can be accessed by a user space process 108 without the baseboard management controller 170 first successfully authenticating the user space process 108. In accordance with example implementations, the authentication includes the baseboard management controller 170 verifying the identity of the user space process 108, and the baseboard management controller 170 determining the extent (if any) of access allowed for the verified identity. The baseboard management controller 170 may restrict access by the user space process 108 according to a set of permissions, or privileges, that are assigned to the particular verified identity. In an example, a user space process 108 may have a set of credential(s) that are associated with a set of permissions that allow access to one or multiple services 174.

In the context that is used herein, a “host interface” refers to an infrastructure through which one or multiple resources of a peripheral device may be accessed. In an example, the host interface 175 may include registers and/or buffers (e.g., input/output (I/O) space or memory-mapped registers and/or buffers) that are written with data corresponding to API requests and provide data representing API responses. In another example, the host interface 175 may be affiliated with communication through a shared memory segment of the system memory 114.

In the context that is used herein, a peripheral device 159, such as the baseboard management controller 170, “authenticating” a user space process 108 refers to the peripheral device 159 verifying the identity of the user space process 108 based on one or multiple credentials that are directly or indirectly provided, by the user space process, to the peripheral device 159. The credentials correspond to trusted user space processes 108. Therefore, authenticating a user space process 108 based on credential(s) both verifies the identity of the user space process 108 and confirms that the user space process 108 is trusted.

In an example, credentials for a user space process 108 may be a password and a user name (or “username”). In another example, credentials for a user space process 108 may include an asymmetric key pair. The public key of the asymmetric key pair may be represented, for example, by a digital certificate (e.g., an X.509 certificate). A peripheral device 159 may, for example, authenticate a user space process by validating a digital certificate that is provided by the user space process, sending the user space process a challenge that is encrypted based on the public key, and determining, based on the user space process' response to the challenge, whether the user space process possesses the private key.

In another example, a credential for a user space process 108 may be a token, such as a JAVASCRIPT Object Notation (JSON) web token (or “JWT”) or an Open Authentication token (or “OAuth token”). A user space process may gain access to a peripheral device 159 by communicating the token to the peripheral device 159. In another example, a credential for a user space process 108 may be a number that is randomly or pseudorandomly generated. In another example, a credential for a user space process 108 may be a secret that is shared with the peripheral device 159.

In accordance with example implementations, the computer platform 100 includes a host credential management infrastructure that manages credentials that allow user space processes 108 to access resources of a peripheral device, such as peripheral device 159. In this context, “managing” credentials includes controlling, or administering, one or multiple aspects of the credentials. In an example, managing the credentials may include provisioning the credentials. In another example, managing credentials may include controlling, or regulating, the validity of the credentials, such as, for example, regulating whether a potential set of credential(s) is valid or is revoked. In another example, managing credentials may include assigning permissions to the credentials. In an example, a set of permissions assigned to a particular set of credential(s) may control the particular service(s) that a user space process 108 may access. In another example, a set of permissions may control whether a user space process 108 may modify, or write, to a memory of the peripheral device 159. In another example, a set of permissions may control whether a user space process 108 may read from a particular memory of the peripheral device 159.

The host credential management infrastructure, in accordance with example implementations, includes a verification agent 172 of the peripheral device 159 and a helper agent 106 of the kernel 104. As further described herein, depending on the particular implementation, the verification agent 172 may provision credential(s) for a user space process 108 based on the verification agent's determination of the process' trustworthiness. In an example, the verification agent 172 may evaluate the trustworthiness of a particular user space process 108 based on a TOFU trust model. In another example, the verification agent 172 may evaluate the trustworthiness of a particular user space process 108 based on an expected state trust model.

As described further herein, in accordance with example implementations, the helper agent 106 includes a registration API 107. A user space process 108 may request a set of one or multiple credentials that allow the process 108 to access one or multiple resources (e.g., services) of the peripheral device 159 by calling the registration API 107. An API call to the registration API 107 initiates a registration phase. In accordance with example implementations, the registration phase is a sequence of operations in which the host credential management infrastructure evaluates the trustworthiness of the calling user space process 108, and if the host credential management infrastructure determines that the user space process 108 is trustworthy, then the infrastructure provisions credentials for the user space process 108.

More specifically, in accordance with example implementations, responsive to an API call to the registration API 107, the helper agent 106 provides a report 105 (herein called the “initial report 105”) to the verification agent 172. As further described herein, the report 105 may contain data and metadata that represent initial runtime integrity measurements of a user space process 108. In an example of a runtime integrity measurement, the report 105 may contain data that represents a runtime digest 111 of the user space process 108. The initial report 105 may also contain metadata 112 that represents other non-digest runtime integrity measurements (called “attributes”) of the user space process 108. In examples, an attribute may be a binary file name, a process path, a passed command parameter, an environment variable, an extent of a text segment associated with the user space process 108, a permission associated with a segment of a user space process, or other attribute. The verification agent 172 of the peripheral device 159 processes the information that is contained in the initial report 105 for purposes of determining whether the user space process 108 is trustworthy.

If the verification agent 172 determines that the user space process 108 is trustworthy, then the verification agent 172 provisions credential(s) for the user space process 108, which the user space process 108 may then use to access one or multiple resources (e.g., one or multiple services) of the peripheral device 159. If the verification agent 172 determines that the user space process 108 is not trustworthy, then the integrity verification agent 172 denies the registration request and accordingly does not provision any credentials for the user space process 108. A user space process 108 that has received credential(s) and for which the credential(s) are valid is referred to as a “registered” user space process 108 herein.

In addition to sending the initial report 105 to the verification agent 172, in accordance with example implementations, the helper agent 106 may, in connection with re-verification requests, send subsequent reports 105 (called “runtime reports 105” herein) to the verification agent 172 for a particular registered user space process 108. The verification agent 172 may use these subsequent reports 105 to monitor the trustworthiness of a registered user space process 108. In this way, should the verification agent 172 determine that the information that is contained in a particular runtime report 105 indicate that a user space process 108 is no longer trustworthy, the verification agent 172 may revoke the credential(s) of the user space process 108.

The “provisioning” of credential(s) for a particular user space process 108, in the context that is used herein, refers to the creation of the credential(s) and the configuration, or setting up, of a computer platform 100 to use the credential(s). In an example of provisioning credential(s) for a user space process 108, the verification agent 172 may generate an asymmetric pair of cryptographic keys and a corresponding digital certificate. The verification agent 172 may then communicate the private key and the digital certificate to the helper agent 106, and the helper agent 106 may provide the private key and the digital certificate to the user space process 108. In another example of provisioning credential(s) for a user space process 108, the verification agent 172 may generate a token for a user space process and send the token to the helper agent 106. The helper agent 106 may then provide the token to the user space process 108.

In another example, a credential for a user space process 108 may be a number. In this manner, provisioning the credential includes the verification agent 172 generating a number (e.g., generating the number using a random number generator or a pseudorandom number generator), and the verification agent 172 sending the number to the helper agent 106. The helper agent 106 may then provide the number to the user space process 108.

In accordance with example implementations, provisioning credential(s) for a user space process 108 includes the verification agent 172 associating a set of one or multiple permissions with the credential(s) for purposes of controlling the scope of access of the user space process 108. In an example, a permission may control whether or not the user space process 108 can use a particular service or group of services of the peripheral device 159. In another example, a permission may control whether or not the user space process 108 can access a particular resource (e.g., a register, a memory or an API) of the peripheral device 159. In another example, a permission may control whether or not the user space process 108 can perform a certain operation (e.g., read, write or modify) in associated with a particular resource of the peripheral device 159.

The report 105 represents a state of a particular user space process 108. In the context that is used herein, the “state” of a user space process 108 refers to a collection of one or multiple characteristics of the user space process. In an example, the state of a user space process 108 may include one or multiple integrity measurements corresponding to the user space process 108.

The helper agent 106, in accordance with example implementations, measures runtime-invariant memory content (also called “invariant memory content” herein) corresponding to a user space process 108 for purposes of deriving a runtime digest for the user space process 108. More specifically, running in kernel context, the helper agent 106 has access to the memory mappings of the user space process 108. These mappings, in turn, allow the helper agent 106 to identify one or multiple runtime-invariant parts of memory space occupied by the user space process 108. In this context, an “invariant part” (or “runtime-invariant part”) of the memory space occupied by the user space process 108 refers to a portion of in-memory content that corresponds to the user space process 108 and which is not expected to change while the process 108 runs, or executes.

In an example, a runtime-invariant part of a user space process 108 may be a memory text segment that is associated with the process 108. A “text segment,” in this context, refers to a portion of memory that contains runtime-invariant machine-executable instructions and/or runtime-invariant variable initializations. In an example, the text segment corresponds to a read-only memory portion.

The helper agent 106 measures the identified runtime-invariant part(s) of the memory space content occupied by a user space process 108 for purposes of deriving a runtime digest (called a “runtime digest D_{RUNTIME}” herein) for the user space process 108. In an example, the runtime digest D_{RUNTIME} may be a hash of text segment content associated with a user space process 108, as described below in Equation (Eq.) 1:

$${D}_{RUNTIME} = Hash ( Text Segment Content ) , \qquad Eq . 1$$

where “Hash ( )” represents the application of a cryptographic hash algorithm, and for this particular example, the cryptographic hash algorithm has, as its input, content from one or multiple in-memory text segments corresponding to the user space process 108.

In another example, the runtime digest D_{RUNTIME} may be derived from integrity measurements of the content M1 to M5 from five respective in-memory text segments. The resulting runtime digest D_{RUNTIME}, for this example, is a cumulative hash, as described below:

$${D}_{RUNTIME} = H ( ( H ( H ( H ( H ( M 1 ) \vert \vert M 2 ) \vert \vert M 3 ) \vert \vert M 4 ) ) \vert \vert M 5 ) , \qquad Eq . 2$$

where “H( )” represents the application of a cryptographic hash algorithm, and “| |” represents a concatenation operator. The helper agent 106 may derive a runtime digest D_{RUNTIME} from hash(es) of content from fewer than five in-memory segments or more than five in-memory text segments, in accordance with further implementations.

In accordance with some implementations, the helper agent 106 may derive the runtime digest D_{RUNTIME} using a security processor of the computer platform 100, such as a trusted platform module (TPM) 188. In an example, the helper agent 106 may, via an API call to the security processor, pass text segment content to the security processor and invoke a hashing operation by the security processor's hashing engine. The security processor may then return the corresponding hash, or digest, that is produced by the hashing operation. To determine a runtime digest D_{RUNTIME} that is formed from multiple hash operations (e.g., the cumulative hash described in Eq. 2 above), the helper agent 106 may invoke several hashing operations by the security processor's hashing engine. In another example, the helper agent 106 may determine a runtime digest D_{RUNTIME} through the execution of hash generating, machine-readable instructions.

In another example, the helper agent 106 may use a security processor of the baseboard management controller 170 to generate a runtime digest D_{RUNTIME}. In another example, the helper agent 106 may use a cryptographic processor other than a security processor to generate the digest D_{RUNTIME}. In another example, the helper agent 106 may use a hashing engine that is not part of a security processor, cryptographic process or baseboard management controller.

In the context that is used herein, a “hash” (which may also be referred to by such terminology as a “digest,” “hash value,” or “hash digest”) is produced by the application of a cryptographic hash algorithm to an input value. A cryptographic hash algorithm receives an input value, and the cryptographic hash algorithm generates a hexadecimal string (the digest, or hash) to match the input value. In an example, the input value may include a string of data (for example, a data structure in memory denoted by a starting memory address and an ending memory address).

In such an example, based on the string of data, the cryptographic hash algorithm outputs a hexadecimal string (the digest, or hash). Any minute change to the input value alters the output hexadecimal string. In examples, the cryptographic hash function may be a secure hash algorithm (SHA), a Federal Information Processing Standards (FIPS)-approved hash algorithm, a National Institute of Standards and Technology (NIST)-approved hash algorithm, or any other cryptographic hash algorithm. In some examples, instead of a hexadecimal format, another format may be used for the string.

In accordance with further implementations, the helper agent 106 may determine a runtime digest D_{RUNTIME} for a user space process based on content other than text segment content associated with the process 108. For example, in accordance with some implementations, the runtime digest D_{RUNTIME} may be formed from a concatenation of text segment content associated with the user space process 108 and one or multiple non-text segment runtime invariants, as described below:

$${D}_{RUNTIME} = Hash ( Text Segment Content \vert \vert Non ‐ Text Segment Invariant ) . \qquad Eq . 3$$

In an example, a non-text segment runtime invariant may be a process path of the user space process 108. In another example, a non-text segment runtime invariant may be a name of an executable file corresponding to the user space process 108, including passed arguments. In another example, a runtime non-text segment invariant may be an executable version number. Regardless of the particular non-text segment runtime invariant(s) that are used as hash function inputs to derive a runtime digest D_{RUNTIME}, the runtime invariants are expected to be static during the runtime of the user space process 108. One or multiple runtime invariants may also be represented by the metadata 112 of the report 105.

In another example, the helper agent 106 may derive a runtime digest D_{RUNTIME} from text segment content associated with the user space process 108 and text segment content from libraries that are dynamically linked by the operating system to the user space process 108. For example, in accordance with some implementations, the helper agent 106 may determine the runtime digest D_{RUNTIME} based on text content from N libraries, as described below:

$${D}_{RUNTIME} = Hash ( Text Segment Content \vert \vert Library 1 Text \vert \vert … \vert \vert Library N Text ) , \qquad Eq . 4$$

where the library text (e.g., “Library 1 Text” or Library N”) refers to runtime invariant content of a particular library. In accordance with some implementations, the executable files and libraries associated with the user space process 108 may be compiled as position independent executables (PIE) and position independent code (PIC), respectively, which are loaded at arbitrary memory addresses. This has the benefit of enhancing the difficulty for attackers to correctly exploit execution.

The helper agent 106 may, responsive to a call to the registration API 107, determine a current state of the user space process 108 and send, to the verification agent 172, an initial report 105 that represents the current state of the user space process 108. The verification agent's use of the current state, as represented by the report 105, depends on the particular trust model that is used by the verification agent 172. By applying the particular trust model, the verification agent 172 evaluates the user space process 108 to determine whether the verification agent 172 trusts the user space process 108. Responsive to the verification agent 172 trusting the user space process 108, the verification agent 172 provisions the credential(s) for the user space process 108. If the verification agent 172 determines that the user space process 108 is untrustworthy, then the verification agent 172 denies the registration request and does not provision any credentials for the user space process 108.

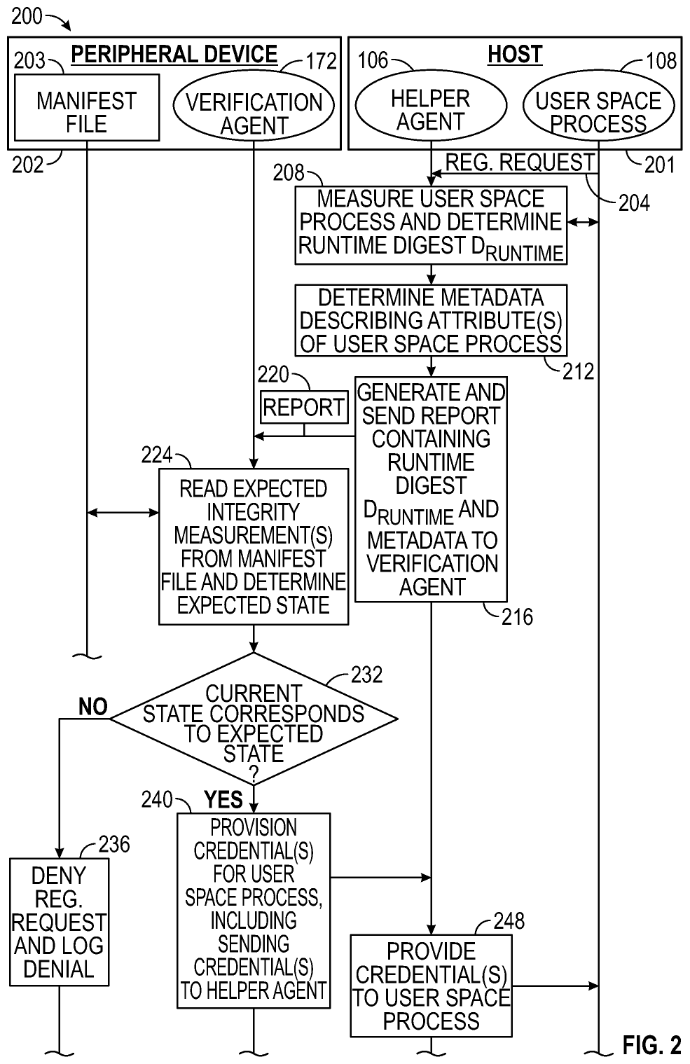

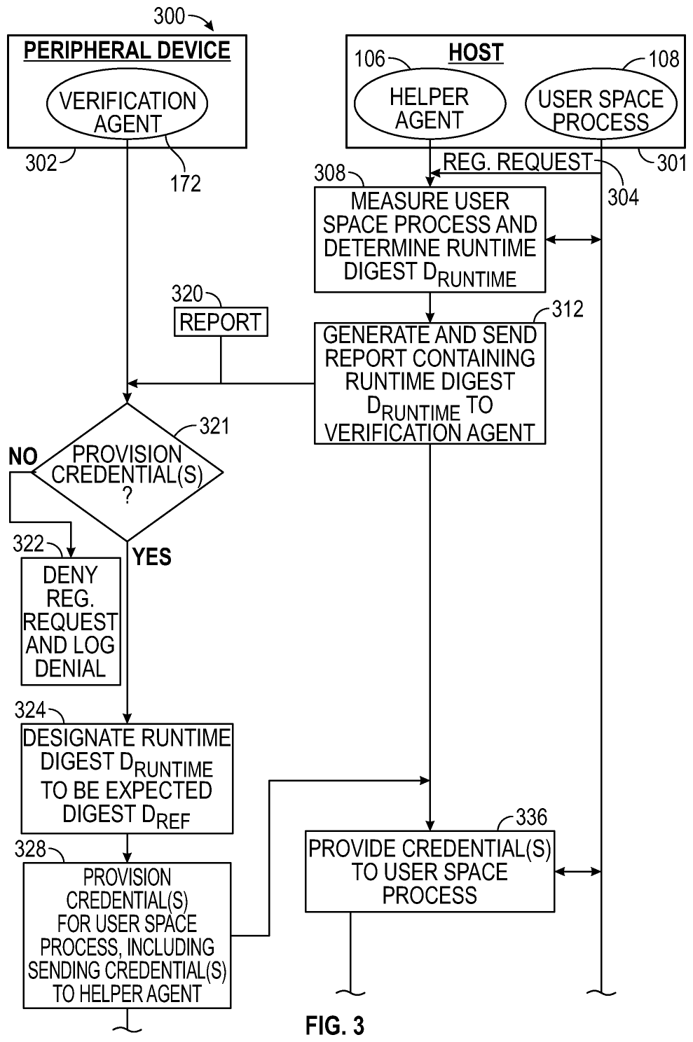

In an example, the verification agent 172 may adhere to an expected state trust model in which a user space process 108 is not trusted unless the current state represented by the initial report 105 corresponds to an expected state for the user space process 108, as further described herein in connection with FIG. 2. In another example, the verification agent 172 may adhere to a TOFU trust model for purposes of evaluating the trustworthiness of the user space process 108, as further described herein in connection with FIG. 3.

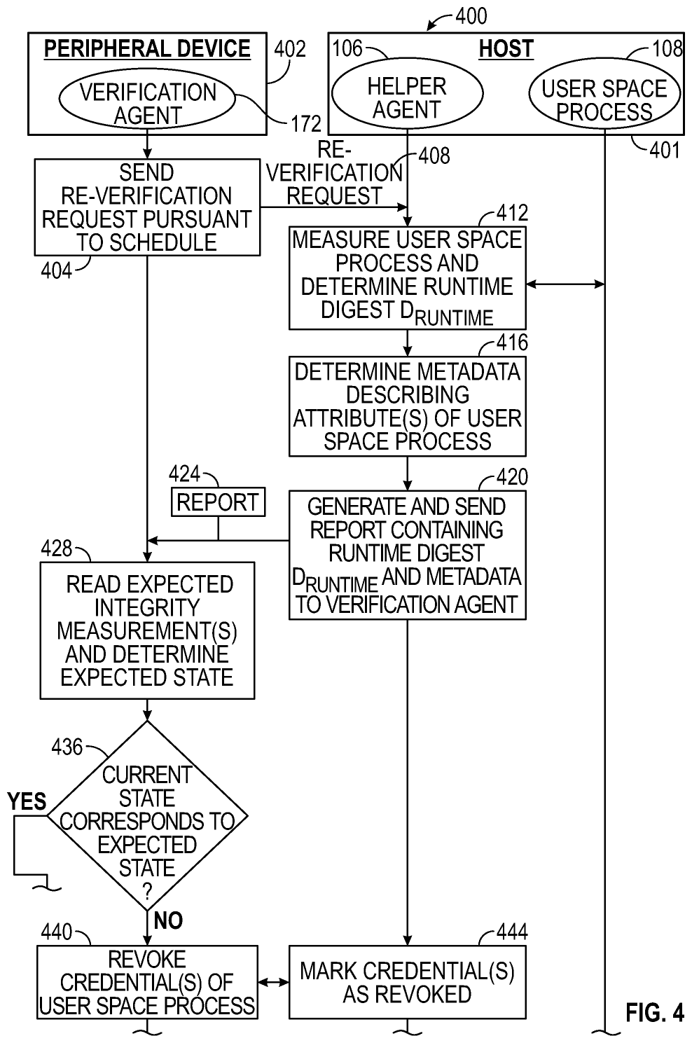

The verification agent 172, in accordance with example implementations, may use re-verification requests to monitor the integrity of a user space process 108 so that should the user space process 108 become untrustworthy, the verification agent 172 may revoke the corresponding credential(s). More specifically, the verification agent 172 may send a re-verification request to the helper agent 106 for purposes of requesting the helper agent 106 to determine a current state of a registered user space process 108. In an example, the verification agent 172 may, for each registered user space process 108, send re-verification requests to the helper agent 106 according to a particular schedule (e.g., at times corresponding to a periodic schedule). As described further herein in connection with FIG. 4, for a particular user space process 108, the verification agent 172 evaluates the corresponding reports 105 for purposes of determining whether to continue trusting the user space process 108 or whether to determine that the user space process 108 is untrustworthy and revoke the credential(s) assigned to the process 108.

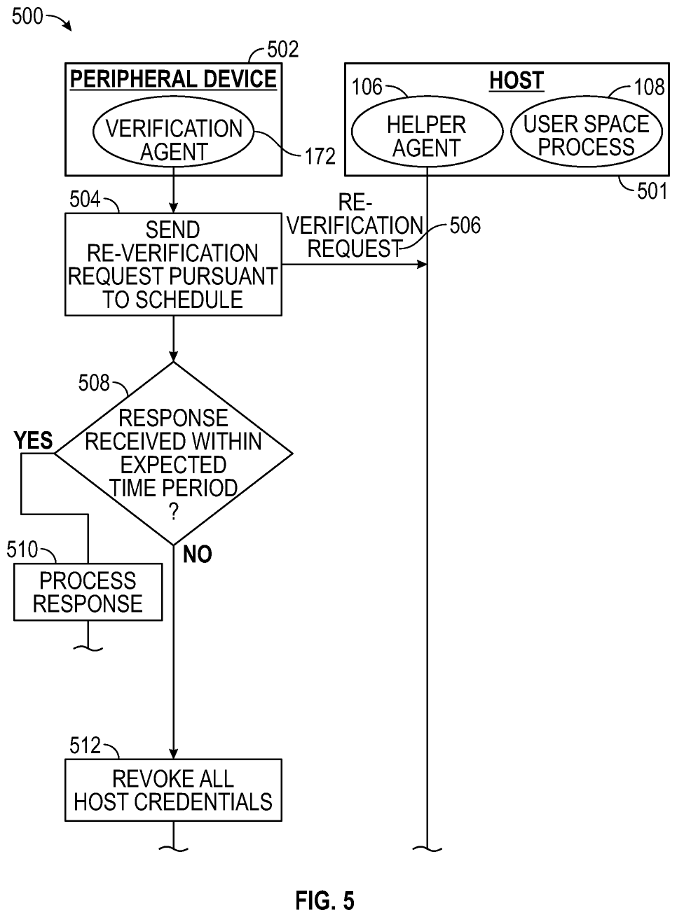

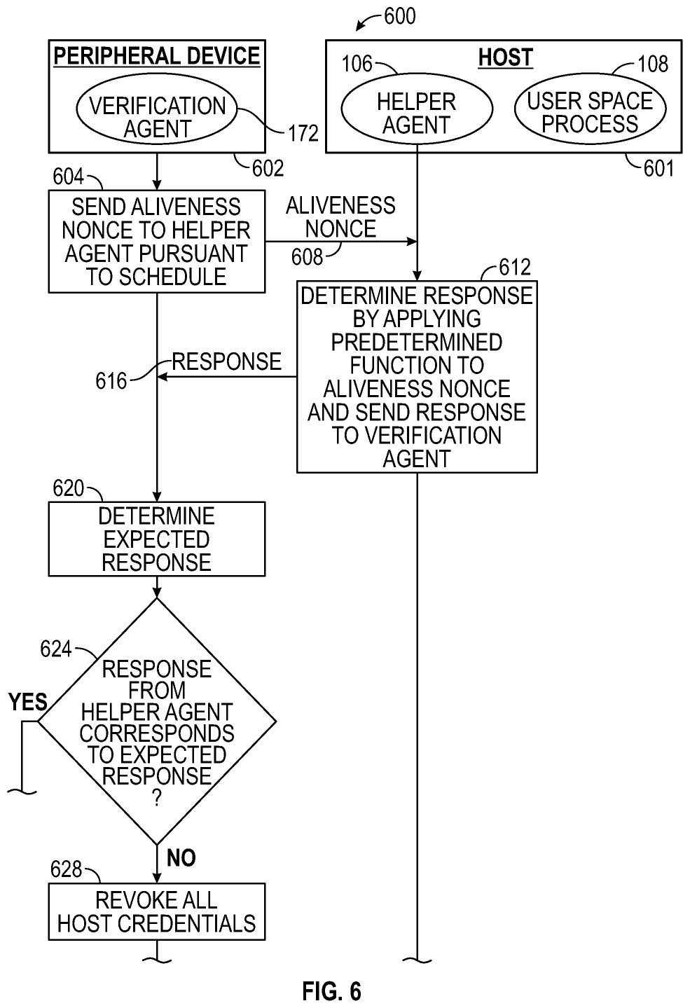

As described further herein in connection with FIG. 5, in accordance with example implementations, the verification agent 172 may use the re-verification requests and corresponding responses as a mechanism to detect potential tampering with the host credential management infrastructure. Moreover, the verification agent 172 may undertake one or multiple other measures to monitor the host credential management infrastructure for tampering, such as a measure that includes the verification agent 172 sending aliveness nonces to the helper agent, as described further herein in connection with FIG. 6.

Still referring to FIG. 1, the helper agent 106 and the verification agent 172 may exchange messages over a secure communication channel. In the context that is used herein, a “communication channel” refers to a logical and/or physical infrastructure to transfer messages between entities. In an example, the communication channel may be associated with shared memory message transfers. In this manner, the helper agent 106 and the verification agent 172 may exchange messages (e.g., reports 105, acknowledgements, aliveness messages, registration requests, credential information messages, registration denials, registration grants, and/or other communications) using a memory segment (e.g., a memory segment of the system memory 114) that is shared between the helper agent 106 and the verification agent 172. For example, the helper agent 106 may write to a shared memory segment with data representing a report 105, and the verification agent 172 may read data representing the report 105 from the shared memory segment. In another example, the verification agent 172 may write data to a shared memory segment representing a credential for a particular user space process 108, and the helper agent 106 may read the data from the shared memory segment.

In another example, the communication channel between the helper agent 106 and the verification agent 172 may be associated with a network protocol. For example, the helper agent 106 and the verification agent 172 may communicate using a network protocol via a socket of the kernel 104. For example, the socket may be a stream socket, and the helper agent 106 and the verification agent 172 may form a network connection. In another example, the socket may be a datagram socket, and communications between the helper agent 106 and the verification agent 172 may be connectionless. In another example, the communication channel may include a management protocol socket interface of the kernel 104. For example, the helper agent 106 may communicate with the verification agent 172 via a Management Component Transport Protocol (MCTP) socket of the kernel 104.

The communication channel between the helper agent 106 and the verification agent 172 may be protected by authenticated encryption, in accordance with some implementations. Authenticated encryption has the benefits of assuring message confidentiality and authenticity. In an example, the verification agent 172 may, responsive to a boot of the computer platform 100, provide the helper agent 106 with a session key (e.g., a randomly-generated cryptographic key or a pseudorandomly-generated cryptographic key), and communications between the verification agent 172 and the helper agent 106 may be encrypted using the session key. In an example, the authenticated encryption may use an Advanced Encryption Standard-Galois Counter Mode (AES-GCM) algorithm. In another example, the authenticated encryption may use an AES-GCM-SIV algorithm, which is the AES-GCM algorithm used with a synthetic initialization vector (SIV).

A user space process 108, responsive to registering via the API 107 and successfully obtaining credential(s), may bootstrap a communication channel with a host interface 175 of the peripheral device 159. In accordance with example implementations, the user space process 108 may send a request to the peripheral device 159 for a connection. The request, in turn, prompts the host interface 175 to authenticate the user space process 108. In an example, the request may contain the credential(s), which allows the host interface 175 to authenticate the user space process 108 based on the provided credential(s). In another example, the request may initiate an exchange of messages between the host interface 175 and the user space process 108 for purposes of the user space process 108 providing proof that the user space process 108 possesses the credential(s). In response to host interface successfully authenticating the user space process 108, the host interface 175 may then proceed with operations to set up the communication channel with the user space process. Otherwise, for unsuccessful authentication, the host interface 175 denies the request.

In accordance with example implementations, the communication channel between the host interface 175 and the user space process 108 may be any of the communication channels described above for the helper agent 106 and verification agent 172 communication. Moreover, in accordance with example implementations, the communication channel between the host interface 175 and the user space process 108 may be protected by authenticated encryption, such as an encryption based on the AES-GCM algorithm or AES-GCM-SIV algorithm. In an example, a session key for the communication channel may be generated by the host interface 175.

In accordance with example implementations, a user space process 108 may communicate with the helper agent 106 using any of a variety of communication channels. In an example, the helper agent 106 and a user space process 108 may communicate using a Netlink socket of the kernel 104. In another example, the helper agent 106 and a user space process 108 may communicate using system calls. In another example, the helper agent 106 and a user space process 108 may communicate using I/O control (or “IOCTL”) calls. In another example, the helper agent 106 and a user space process 108 may communicate using Direct I/O calls.

In accordance with example implementations, the helper agent 106 may be an extension of the operating system kernel 104. In an example, helper agent code 134 may be stored in a storage device 130 and may correspond to the helper agent 106. In an example, for a LINUX operating system, the helper agent code 134 may correspond to a loadable kernel module (LKM) that is loaded on demand each time the kernel 104 boots, and after the LKM is loaded, the LKM becomes part of the operating system kernel 104. In another example, the helper agent 106 may be a kernel driver. In another example, for a LINUX operating system, the helper agent 106 may be may be added to the operating system kernel 104 as an eBPF module. An eBPF module is a program that is outside of the compiled LINUX core and runs in a sandbox in a privileged context inside the LINUX kernel. Although initially, the acronym “eBPF” referred to an “extended Berkeley Packet Filter,” the term “eBPF” is a standalone term that encompasses privileged context and sandboxed programs other than programs that perform packet filtering. In another example, the helper agent 106 may be part of, and therefore integrated into, the operating system kernel 104.

In an example, the helper agent 106 may be loaded as part of a secure and measured boot of the computer platform 100. In this manner, it may be assumed that a chain of trust rooted in a secure Root of Trust is created for booting the computer platform 100 to a trusted state, such that there is sufficient confidence that no tampering has occurred with the kernel 104 or the helper agent 106 before the current boot. In an example, the baseboard management controller 170 may store reference measurements (e.g., platform configuration register (PCR) measurements) so that the baseboard management controller 170 may verify that the computer platform 100 has booted as expected. In another example, in a remote attestation, the baseboard management controller 170 may attest the reference measurements to a remote verification service for purposes of the remote verification service appraising the trustworthiness of the computer platform 100. In accordance with example implementations, the baseboard management controller 170 may initiate one or multiple responsive actions (e.g., powering down the computer platform 100, isolating the computer platform 100 from external connections, or other actions) in response to the computer platform 100 not being booted into a known good state.

In accordance with example implementations, the helper agent 106 may be configured to start early in the kernel initialization process, well before the user space 115 is initialized for purposes of reducing the chances of a malevolent actor compromising the host credential management infrastructure. In an example, for a LINUX operating system, the helper agent code 134 may be loaded from an initial RAM disk (or “ramdisk”). In an example, the initial ramdisk may be loaded pursuant to an initrd (initial ramdisk) scheme. In another example, the helper agent code 134 may be loaded pursuant to an initial RAM file system (or “initramfs”) scheme. After the helper agent 106 connects to the verification agent 172, the peripheral device 159 does not allow another connection until the computer platform 100 is reset or rebooted.

Although, as depicted in FIG. 1, the peripheral device 159 may be a baseboard management controller 170, the peripheral device 159 may be, in accordance with further implementations, a component other than a baseboard management controller. In an example, the peripheral device 159 may be a graphics processing unit (GPU).

In another example, the peripheral device 159 may be a smart I/O peripheral device 119. In the context that is used herein, a “smart I/O peripheral device” refers to a component of a computer platform, which provides one or multiple functions for a host of the computer platform, which, in legacy architectures have been controlled by the host. A smart I/O peripheral may be also be referred to as a “data processing unit,” or “DPU.” In general, a smart I/O peripheral device is a hardware processing unit that has been assigned (e.g., programmed with) a certain personality. The smart I/O peripheral device may provide one or multiple backend I/O services (or “host offloaded services) in accordance with its personality. The backend I/O services may be non-transparent services (e.g., hypervisor virtual switch offloading services) or transparent services (encryption services, overlay network access services and firewall-based network protection services). In an example, one or multiple hardware processors of the smart I/O peripheral device 119 may execute machine-readable instructions to provide the verification agent 172. In another example, dedicated hardware of the smart I/O peripheral device 119, which does not execute machine-readable instructions, may provide the verification agent 172. In examples, the dedicated hardware may be a field programmable gate array (FPGA), an application specific integrated circuit (ASIC), a programmable logic device (PLD), or another electronic device. In accordance with further implementations, the smart I/O peripheral device 119 may provide the verification agent 172 using a combination of dedicated hardware and hardware that executes machine-readable instructions.

For the example implementation that is depicted in FIG. 1 and further described herein, the peripheral device 159 is a baseboard management controller 170. In an example, the baseboard management controller 170 may be an embedded system that is mounted to a motherboard of the computer platform 100. In accordance with example implementations, the baseboard management controller 170 may contain one or multiple semiconductor packages (or “chips”) and one or multiple semiconductor die. In accordance with further implementations, the baseboard management controller 170 may be an expansion card that is connected to a connector slot that is located on a motherboard of the computer platform 100. The baseboard management controller 170 may not contain semiconductor package(s) mounted to the motherboard and may not be associated with an expansion card, in accordance with further implementations.

Regardless of its particular form or implementation, the baseboard management controller 170, in general, may include one or multiple general purpose embedded processing cores 154 (e.g., CPU processing cores), which may execute machine-readable instructions 156 that are stored in a memory 155 of the baseboard management controller to provide the verification agent 172. In accordance with further implementations, the baseboard management controller 170 may provide the verification agent 172 using dedicated hardware of the baseboard management controller 170, which does not execute readable machine-readable instructions. In examples, the dedicated hardware may be an FPGA, an ASIC, a PLD, or another electronic device.

In the context that is used herein, a “baseboard management controller” is a specialized service processor that monitors the physical state of a computer platform or other hardware using sensors and communicates with a management system through a management network. The baseboard management controller 170 may communicate with applications executing at the operating system level through an IOCTL interface driver, a representational state transfer (REST) API, or some other system software proxy that facilitates communication between the baseboard management controller and applications. The baseboard management controller 170 may have hardware level access to hardware devices of the computer platform 100, including the system memory 114. The baseboard management controller 170 may be able to directly modify the hardware devices. The baseboard management controller 170 may operate independently of the operating system of the computer platform 100. The baseboard management controller 170 may be located on the motherboard or main circuit board of the computer platform 100. The fact that a baseboard management controller is mounted on a motherboard of the managed server/hardware or otherwise connected or attached to the managed server/hardware does not prevent the baseboard management controller from being considered “separate” from the server/hardware. As used herein, a baseboard management controller has management capabilities for sub-systems of a computing device, and is separate from a processing resource that executes an operating system of a computing device. As such, the baseboard management controller 170 is separate from the hardware processor(s) 110, which execute instructions corresponding to the operating system kernel 104.

In accordance with example implementations, the baseboard management controller 170 has a management plane and a separate, security plane. Through its management plane, the baseboard management controller 170 may provide various management services for the computer platform 100. One or multiple of these management services may be the service(s) 174 used by one or multiple user space processes 108. As examples, management services provided by the baseboard management controller 170 may include monitoring sensors (e.g., temperature sensors, cooling fan speed sensors); monitoring operating system status; monitoring power statuses; logging computer platform 100 events; providing the capability to mount virtual media; providing the capability to boot the computer platform 100 from virtual media; providing remotely-controlled management functions for the computer platform 100; and other management services.

Through its security plane, the baseboard management controller 170, in accordance with example implementations, provides security functions, or services, for the computer platform 100, such as key management (e.g., functions relating to storing and loading cryptographic keys), firmware image validation, platform cryptographic identity retrieval, measurement hash loading, measurement hash retrieval; and other security services. In accordance with example implementations, as part of its security plane, the baseboard management controller 170 may validate and load firmware instructions from firmware 176 that is stored in a non-volatile memory 184 (e.g., a flash memory) of the computer platform 100. The firmware 176 may include machine-readable instructions corresponding to a management stack of the baseboard management controller 170, and the firmware 176 may include code 177 that is executed by one or multiple processing cores 154 to provide the verification agent 172. As depicted in FIG. 1, the baseboard management controller 170 may be coupled to the non-volatile memory 184 through a bus 183 (e.g., a Serial Peripheral Interface (SPI) bus or other bus).

Among its other features, the computer platform 100 may include one or multiple I/O bridges 118; one or multiple mass storage devices 130; one or multiple network interface cards (NICs) 113; one or multiple TPMs 188; I/O devices (e.g., a keyboard, mouse, a trackpad, a display, and so forth); and other electronic devices.

The baseboard management controller 170, the NIC(s) 113, the TPM(s) 188 and the processors 110 may, in accordance with example implementations, communicate through the I/O bridge(s) 118; and the storage device(s) 130 may be coupled to the processors 110 through the I/O bridge(s) 118. As depicted in FIG. 1, in accordance with some implementations, the storage device(s) 130 may store an operating system image 132 (corresponding to the operating system kernel 104), operating system bootloader code (corresponding to an operating system bootloader), helper agent code 134 (corresponding to the helper agent 106); and application code 136 (corresponding to applications 103). For the example implementation of FIG. 1, a NIC 113 couples the I/O bridge(s) 118 to network fabric 190. In accordance with further example implementations, the baseboard management controller 170 may contain a NIC that communicates with the network fabric 190.

In general, the network fabric 190 may be associated with one or multiple types of communication networks, such as (as examples) Fibre Channel networks, Compute Express Link (CXL) fabric, dedicated management networks, local area networks (LANs), WANs, global networks, wireless networks, or any combination thereof.

The TPM 188 is an example of a security processor of the computer platform 100, which, among other functions, may be used to provide cryptographic services for the computer platform 100 and securely store cryptographic artifacts (e.g., the secure boot variables, hashes to verify integrity measurement, keys, and so forth) for the computer platform 100. In an example, the TPM 188 may be a physical hardware component that is mounted to a motherboard of the computer platform 100. In another example, the TPM 188 may be a virtual TPM (vTPM). In another example, the TPM 188 may be a firmware TPM (fTPM). In accordance with further implementations, the computer platform 100 may not include a TPM.

In accordance with some implementations, the TPM 188 may be constructed to perform one or multiple trusted computing operations that are described in the Trusted Platform Module Library Specification, Family 2.0, Level 00, Revision 01.59 (November 2019), published by the Trusted Computing Group (hereinafter called the “TPM 2.0 Specification”). In accordance with further implementations, the TPM 188 may perform one or multiple trusted computing operations that are not described in the TPM 2.0 Specification. In accordance with further example implementations, the computer platform 100 may contain a security component other than a TPM. In accordance with further implementations, the computer platform 100 may not have a TPM or other security processor. In accordance with further implementations, the computer platform 100 may have a TPM 188 or other security processor but not use the TPM 188/security processor.

In accordance with example implementations, the computer platform 100 may have multiple TPMS 188. In an example, the computer platform 100 may have a host-affiliated TPM 188 that assists the helper agent 106 in cryptographic processing-related operations. Moreover, the computer platform 100 may have another TPM 188 that assists the baseboard management controller 170 in cryptographic processing-related operations. In an example, a TPM 188 may include a random number generator that, via an API call, may generate and return a random number as a response to the API call. In an example, the verification agent 172 may generate an API call to a TPM 188 for purposes of generating a random number that is used as a nonce. The random number generator may generate the random number from an input that is provided by an entropy source. In an example, the random number generator may be a digital random number generator module that is described in Part 1, Section 11.4.11 of the TPM 2.0 Specification.

In another example, a TPM 188 may include a hashing module, or engine, which applies a cryptographic hash algorithm to an input for purposes of providing a hash, or digest. In an example, the hashing engine may apply a cryptographic hash function that is described in Part I, Section 11.4.2 of the TPM 2.0 Specification.

FIG. 2 is a sequence flow diagram 200 depicting a technique to provision credential(s) for a user space process 108 in accordance with example implementations. Referring to FIG. 2, for this example, the host management credential infrastructure includes a helper agent 106 of a host 201 and a verification agent 172 of a peripheral device 202. The host 101 of FIG. 1 is an example of the host 201, and the peripheral device 159 of FIG. 1 is an example of the peripheral device 202.

The verification agent 172, for this example, evaluates the trustworthiness of the user space process 108 based on an expected state trust model. More specifically, the peripheral device 202, for this example, has been provisioned with a signed manifest file 203. The signed manifest file 203 contains a list of expected integrity measurements (e.g., expected digests DREF and additional attributes) as well as additional integrity measurements for applications and/or services that have been approved for use with the peripheral device 202. In an example, the manifest file may have records, where each record is associated with an expected collection of integrity measurements for a user space process 108. In an example, a record may contain an expected digest DREF for a particular associated use space process 108 as well as one or multiple non-digest integrity measurements (or “attributes”) for the user space process 108.

In accordance with example implementations, the user space process 108 provides a registration request 204 to the helper agent 106. In an example, the request 204 may be an API call made to a registration API of the helper agent 106. Responsive to receiving the registration request 204, the helper agent 106 measures runtime-invariant content of the user space process 108 for purposes of deriving, or determining, a corresponding runtime digest D_{RUNTIME}, as depicted at 208. Moreover, determining the runtime digest D_{RUNTIME} may include applying a cryptographic hash algorithm to one or multiple in-memory text segments associated with the user space process 108. In another example, determining the runtime digest D_{RUNTIME} may include the helper agent 106 combining one or multiple measurements of in-memory content with other information, such as one or multiple attributes of the user space process 108 and/or text content from one or multiple libraries that are dynamically linked to the user space process 108. Regardless of the particular methodology used, the underlying assumption is that a corresponding expected digest DREF contained in the manifest file 203 was derived using the same methodology.

As depicted at 212, the helper agent 106 may determine one or multiple non-digest integrity measurements, or attributes, of the user space process 108. Moreover, the helper agent 106 may generate metadata describing the attribute(s). In an example, an attribute may be a process path associated with the user space process 108. In an example, an attribute may be the name of an executable file associated with the user space process 108. In an example, an attribute may be a combination of the name of an executable file associated with the user space process 108 along with one or multiple command parameters passed to the user space process 108. In an example, an attribute may be an environment variable associated with the user space process 108. In an example, an attribute may be an extent of one or multiple text segments associated with the user space process 108. In an example, an attribute may be a permission associated with a particular text segment associated with the user space process 108. As depicted at 216, the helper agent 106 sends, to the verification agent 172, a report that contains the metadata describing the attribute(s) and data representing the runtime digest D_{RUNTIME}.

The verification agent 172 may then, in accordance with example implementations, evaluate the trustworthiness of the user space process 108 for purposes of determining whether or not to issue credential(s) to the user space process 108. Although not depicted in FIG. 2, it is assumed that the verification agent 172 has validated the manifest file 203 based on the signature of the file 203. For purposes of evaluating the trustworthiness of the user space process 108, as depicted in block 224, the verification agent 172 accesses the manifest file 203 to read one or multiple expected integrity measurements for the user space process 108 for purposes of determining an expected state for the user space process 108. In an example, pursuant to block 224, the verification agent 172 may read an expected digest DREF for the user space process 108 from the manifest file 203. In another example, pursuant to block 224, the verification agent 172 may read metadata from the manifest file 203, which represents one or multiple attributes for the user space process 108. The verification agent 172 may then determine, as depicted in decision block 232, whether the current state of the user space process 108 corresponds to the expected state for the user space process 108. If the current state does not correspond to the expected state, then the authentication fails. Otherwise, if the current state of the user space process corresponds to the expected state for the user space process 108, then the authentication passes.

In an example, the current state of the user space process 108 may not correspond to an expected state if the runtime digest D_{RUNTIME} does not match any expected digest DREF contained in the manifest file 203. In another example, the metadata of the report 220 may represent an attribute that, according to the manifest file 203, is unexpected. Accordingly, the current state of the user space process 108 does not correspond to its expected state.

In an example, the metadata of the report 220 may represent a specific environment variable, and metadata of the manifest file 203 may indicate an expectation for this environment variable, which is not met by the user space process 108. More specifically, certain environment variables, are considered potential attack vectors for security attacks. In examples, for the LINUX operating system, environment variables, such as LD_PRELOAD and LD_LIBRARY_PATH, are considered potentially dangerous in a production environment, as an attacker can use them to hijack execution and insert malicious libraries. In an example, the manifest file 203 may identify one or multiple environment variables that are prohibited from being used in connection with the user space process 108 (and as such, the user space process 108 is not expected to use these environment variable(s)). In another example, a manifest file 203 may identify a specific environment variable that is expected to be used in a certain way. For example, a malevolent agent may use a particular environment variable to load a malicious library that has a name that matches the name of a legitimate, or authorized, library.

The manifest file 203, may for example, identify an environment variable and indicate an expectation of how the variable is used. In an example, the manifest file 203 may identify a value for the environment variable. The value represents a path of a library to be loaded by the operating system. Therefore, if the user space process 108 is associated with a particular environment variable that is not being used as expected, then the current state of the user space process 108 does not correspond to its expected state.

In another example, the metadata of the report may represent a process path of the user space process 108, which may be different than an expected process path for the user space process 108, as indicated by metadata of the manifest file 203. In another example, the metadata of the report 220 may represent an unexpected name for the executable file that corresponds to the user space process 108, as compared to the expected name represented by metadata of the manifest file 203. In another example, the metadata for the report 220 may represent an unexpected command parameter being passed to the user space process 108, as compared to expected command parameters represented by metadata of the manifest file 203.

In accordance with example implementations, responsive to a determination (decision block 232) that the current state of the user space process 108 does not correspond to the expected state, the verification agent 172 denies the registration request, as depicted at 236. Moreover, in accordance with example implementations, the verification agent 172 logs the denial of the request, as depicted at 236. In accordance with some implementations, the verification agent 172 may perform different and/or one or multiple responsive actions in response to determining that the current state of the user space process 108 does not correspond to the expected state for the user space process 108.

A “responsive action,” in the context that is used herein, refers to a measure to counter actual or potential tampering activity. In an example, a responsive action may include denying a credential request, as described herein. In another example, a responsive action may include logging the denial of the credential request, as described herein. In an example, a responsive action may include powering down a computer platform containing the peripheral device 202 and the host 201. In another example, a responsive action may include rebooting the computer platform. In another example, a responsive action may include generating data for purposes of generating an alert for an administrative dashboard. In another example, a responsive action may include sending an alert message to a system administrator. In another example, a responsive action may include sending an alert message to a remote management server (e.g., the remote management server 194 of FIG. 1). In another example, a responsive action may include imposing a restriction that a certain password, key or other credential (e.g., a credential supplied by a system administrator) is to be provided before the computer platform is allowed to reboot. In another example, a responsive action may include quarantining the computer platform from an external network. In another example, a responsive action may include quiescing operations of the computer platform associated with an external entity. In accordance with some implementations, the verification agent 172 may select one or multiple responsive action(s) for initiation based on a predefined policy that defines responsive actions and criteria for triggering the responsive actions.

If, as depicted at 232, the verification agent 172 determines that the current state of the user space process 108 corresponds to the expected state for the user space process 108, then the verification agent 172 initiates actions to provision the credential(s) for the user space process 108, as depicted at 240. The provisioning includes the verification agent 172 generating the credential(s) and sending the credential(s) to the helper agent 106, as depicted at 240. The provisioning may also include the verification agent 172 recording the credential(s) and associating the credential(s) with the expected digest DREF. Moreover, the provisioning may include the helper agent 106 providing the credential(s) to the user space process, as depicted at 248.

FIG. 3 is a sequence flow diagram 300 depicting a technique to provision credential(s) for a user space process 108, in accordance with a further example implementation. Referring to FIG. 3, for this example, the technique uses a host management credential infrastructure that includes a helper agent 106 of a host 301 and a verification agent 172 of a peripheral device 302. The host 101 of FIG. 1 is an example of the host 301, and the peripheral device 159 of FIG. 1 is an example of the peripheral device 302. The verification agent 172 uses a TOFU trust model for purposes of evaluating whether the user space process 108 may be trusted.

The sequence flow diagram 300 begins with the user space process 108 submitting a registration request 304 to the helper agent 106. As an example of the registration request 304, the user space process 108 may submit an API call to a registration API of the helper agent 106. As depicted at 308, the helper agent 106 measures the user space process 108 and determines a corresponding runtime digest D_{RUNTIME}.

The helper agent 106 then generates and sends a report 320 containing the runtime digest D_{RUNTIME} to the verification agent 172, as depicted at 312. In accordance with some implementations, the report 320 may also contain metadata that describes one or multiple non-digest integrity measurements, or attributes, of the user space process 108. In an example, the attribute(s) may contain information that uniquely identifies a particular user process 108, such as, for example, a name of an executable file that corresponds to the user space process 108 and a process path of the user space process.

As depicted at 321, the verification agent 172 may process the report 320 for purposes of determining whether to provision credential(s) for the user space process 108. With the TOFU trust model, the verification agent 172 trusts the first use of the user space process 108. The verification agent 172 may uniquely identify the user space process 108 based on one or multiple attributes of metadata contained in the report 320. If the verification agent 172 determines that this is not the first use for the user space process 108, then the verification agent 172 denies the registration request and performs one or multiple other actions, such as logging the denial (as depicted at 322) and possibly one or multiple further responsive actions. Moreover, in accordance with some implementations, the verification agent 172 may notify the helper agent 106 about the denial.

As also depicted in FIG. 3, if the verification agent 172 determines that this is the first use of the user space process 108, then the verification agent 172 proceeds by designating (block 324) the runtime digest D_{RUNTIME} to be the expected digest DREF, as depicted at 324. Moreover, in accordance with some implementations, the verification agent 172, in accordance with example implementations, may designate one or multiple attributes of the user space process to be respective expected integrity measurements for the user space process 108.

The verification agent 172 may then initiate actions to provision the credential(s) for the user space process 108. The provisioning includes the verification agent 172 generating the credential(s), as depicted at 328. The provisioning may include the verification agent 172 sending the credential(s) to the helper agent 106, and the helper agent 106 recording the credential(s) and associating the credential(s) with the expected digest DREF, as depicted at 332. Moreover, the provisioning may include the helper agent 106 providing the credential(s) to the user space process 108, as depicted at 336.

FIG. 4 is a sequence flow diagram 400 depicting a technique to monitor the trustworthiness of a user space process 108 and revoke the credential(s) of the user space process 108 if the monitoring reveals that the process 108 is no longer trustworthy. Referring to FIG. 4, the monitoring is performed by a host management credential infrastructure that includes a helper agent 106 of a host 401 and a verification agent 172 of a peripheral device 402. The host 101 of FIG. 1 is an example of the host 401, and the peripheral device 159 of FIG. 1 is an example of the peripheral device 402.

The verification agent 172, as depicted at 404, sends a re-verification request 408 to the helper agent 106 to initiate the re-verification. In an example, the verification agent 172 may send re-verification requests to the helper agent 106 for a particular user space process 108 according to a schedule (e.g., a periodic schedule).

The helper agent 106 responds to the re-verification request 408 as follows. First, in accordance with example implementations, the helper agent 106 measures the user space process 108 and determines the current runtime digest D_{RUNTIME}, as depicted at 412. The helper agent 106 may also, in accordance with example implementations, determine one or multiple integrity measurements other than the current runtime digest D_{RUNTIME}. For example, the helper agent 106 determine one or multiple non-digest integrity measurements, or attributes, of the user space process 108 and determine metadata describing the attribute(s), as depicted at 416. The helper agent 106 may then, as depicted at 420, generate and send, to the verification agent 172, a report 424 that contains data that represents the runtime digest D_{RUNTIME} and the metadata that describes the attribute(s).

The verification agent 172 then performs the following actions to re-evaluate the trustworthiness of the user space process 108. The verification agent 172 reads one or multiple expected integrity measurements for the user space process 108 and determines an expected state for the user space process 108, as depicted at 428. In an example, the verification agent 172 may read one or multiple expected integrity measurements for the user space process 108 from a manifest file (e.g., the manifest file 203 of FIG. 2). In another example, the verification agent 172 and/or reads one or multiple expected integrity measurements for the user space process 108 from a store of initial integrity measurement(s) acquired during registration (e.g., acquired during the TOFU security model-based registration that is depicted in FIG. 3). In an example, an expected state for a user space process 108 may correspond to a particular expected digest DREF and a collection of one or multiple non-digest expected integrity measurements (e.g., an associated file name, a process path, a passed command parameters, an expectation for a specific environment variable, or other user process attribute(s)).

Next, as depicted at 436, the verification agent 172 determines whether the current state of the user space process 108 corresponds to the expected state for the user space process 108. If so, then the verification agent 172 takes no further action for the re-verification, as the user space process 108 is still deemed trustworthy. If, however, the current state of the user space process 108 does not correspond to the expected state for the user space process 108, then the verification agent 172 may revoke the credential(s) of the user space process 108, as depicted at 440, and communicate with the helper agent 106 to cause the helper agent 106 to mark the credential(s) as revoked, as depicted at 444. Moreover, in accordance with some implementations, the verification agent 172 may perform one or multiple additional responsive actions to the revoking of the credential(s), such as logging the revocation, as well as one or multiple other actions.

The verification agent 172 may regularly test the host credential management infrastructure using integrity checks for purposes of determining whether the infrastructure has been subject to tampering. FIG. 5 depicts a sequence flow diagram 500 illustrating one integrity check, which corresponds to the helper agent 106 not being responsive to a re-verification request 504. FIG. 6 depicts a sequence flow diagram illustrating another integrity check of the host credential management infrastructure using an aliveness nonce.

Referring to FIG. 5, for this example, the host management credential infrastructure includes a helper agent 106 of a host 501 and a verification agent 172 of a peripheral device 502. The host 101 of FIG. 1 is an example of the host 501, and the peripheral device 159 of FIG. 1 is an example of the peripheral device 502.

As depicted at 504, the verification agent 172 sends, at a scheduled time, a re-verification request 506 to the helper agent 106. For this example, the helper agent 106 does not respond, within an expected time period, to the re-verification request 506. In an example, the expected time period may be measured from a time that the verification agent 172 sends the re-verification request 506. Stated differently, the verification agent 172 does not receive a response from the helper agent 106 within this predetermined time measured after the sending of the re-verification request 506. In another example, the verification agent 172 may measure a predetermined time period for the helper agent 106 to acknowledge the sending of the re-verification request 506, and the verification agent 172 may not receive an acknowledgement within this expected time period.

In general, the failure of the helper agent 106 to respond within the expected time period may be due to tampering with the host credential management infrastructure, such as, for example, tampering with the operating system kernel and/or helper agent 106. Accordingly, as depicted in FIG. 5, upon determining (as depicted at 508) that a response from the helper agent 106 to the re-verification request 506 was not received within an expected time period, the verification agent 172 revokes all host credentials associated with all registered user space processes 108, as depicted at 512. Moreover, in accordance with some implementations, the verification agent 172 may perform one or multiple other responsive actions due to the nonresponsiveness of the helper agent 106. If, however, the response to the re-verification request 506 is received within the expected time period, then the verification engine 172 processes the response, as depicted at 510. In an example, the processing of the response may proceed according to the sequence flow diagram 400 of FIG. 4, which is discussed above.

Referring to FIG. 6, for this example, the host management credential infrastructure includes a helper agent 106 of a host 601 and a verification agent 172 of a peripheral device 602. The host 101 of FIG. 1 is an example of the host 601, and the peripheral device 159 of FIG. 1 is an example of the peripheral device 602.

As depicted at 604, the verification agent 172 sends an aliveness nonce 608 to the helper agent 106 pursuant to a schedule. For this example, the helper nonce 106 determines, as depicted at 612, a response to the aliveness nonce 608 by applying a predetermined function to the aliveness nonce 608 and sending the response to the verification agent 172.

In an example, the aliveness nonce 608 may be a randomly-generated or pseudorandomly-generated number. In an example, the predetermined function may be a mathematical function that is applied to the aliveness nonce 608. In an example, the predetermined function may be a mathematical function to add a predetermined number to the aliveness nonce 608 to produce a result (a response nonce) that is sent as the response 616.

FIG. 6 depicts the response 616 being received by the verification agent 172. For this example, the verification agent 172 determines, as depicted at 620, an expected response to the aliveness nonce 608. In this manner, the verification agent 172 applies the expected predetermined function to the aliveness nonce 608 for purposes of determining whether the response 616 corresponds to the expected result. If, as depicted at 624, the verification agent 172 determines that the response 616 corresponds to the expected response, then the integrity check of the host credential management infrastructure using the aliveness nonce 608 is complete. Otherwise, if the response is unexpected, then the verification agent 172 may perform or initiate one or multiple responsive actions, including revoking all host credentials associated with registered user space processes 108, as depicted at 628.

Although not depicted in the example shown in connection with FIG. 6, an unexpected response to the aliveness nonce 608 may be the helper agent 106 not responding to the aliveness nonce 616. For this case, the verification agent 172 may perform or initiate one or multiple responsive actions, including revoking all credentials for the registered user space processes 108.

Other techniques may be used to monitor the integrity of the host credential management infrastructure in accordance with further implementations. For example, in accordance with some implementations, the helper agent 106 may be constructed to send heartbeat messages according to an expected schedule (e.g., according to a periodic schedule). The failure of the verification agent 172 receiving a particular heartbeat message within the corresponding expected time period alerts the verification agent 172 to potential tampering with the helper agent 106. Accordingly, the verification agent 172 may initiate one or multiple responsive actions responsive to a heartbeat message not being received within the corresponding expected time period. In another variation, the heartbeat message may have an expected content or format, and the verification agent 172 may initiate one or multiple responsive actions due to a particular heartbeat message not containing conforming to the expected content or expected format.

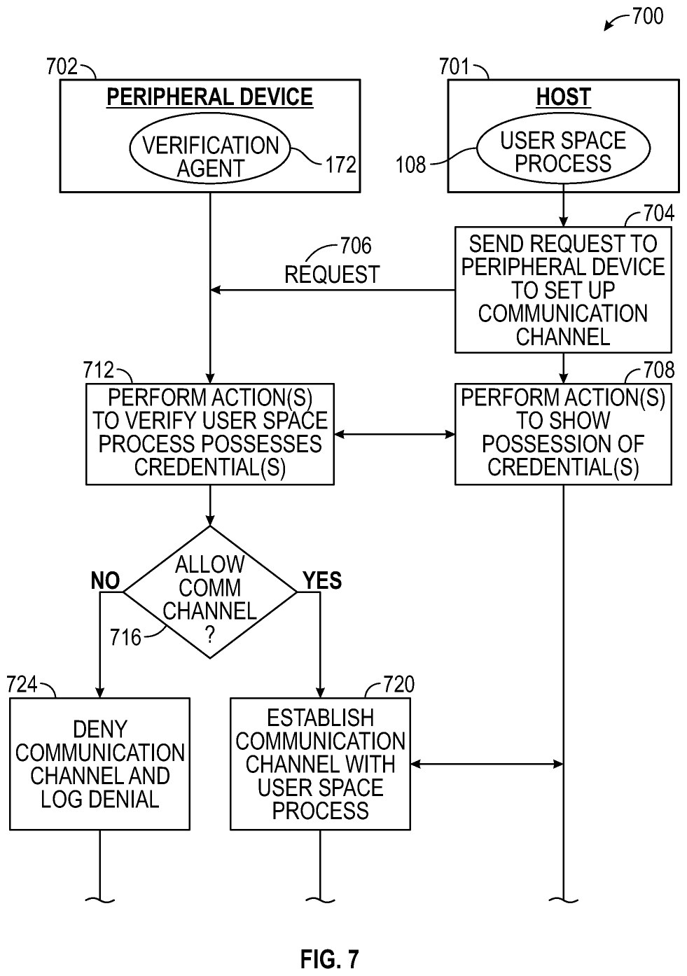

FIG. 7 is a sequence flow diagram 700 depicting a technique to set up a communication channel between a user space process 108 and a peripheral device 702 according to an example implementation. For this example, the user space process 108 is associated with a host 701. The host 101 of FIG. 1 is an example of the host 701. The peripheral device 702 includes a verification agent 172. The peripheral device 159 of FIG. 1 is an example of the peripheral device 702.

The user space process 108 bootstraps the communication channel by sending (as depicted at 704) a request 706 to the peripheral device 702 to set up the communication channel. The verification agent 172 of the peripheral device 702 responds to the request 706 by performing one or multiple actions to verify whether the user space process 108 possesses the credential(s), as depicted at 712. This verification may include the user space process 108 taking one or multiple actions to show possession of the credentials, as depicted at 708. The verification agent 172 may then, as depicted at 716, determine whether to allow the communication channel to be set up, and if so, a management service (e.g., a management service 174 of FIG. 1) of the peripheral device 702 and the user space process 108 may then establish the communication channel, as depicted at 720. Otherwise, as depicted at 724, the verification agent 172 may deny the communication channel and log the denial, among other possible responsive actions.

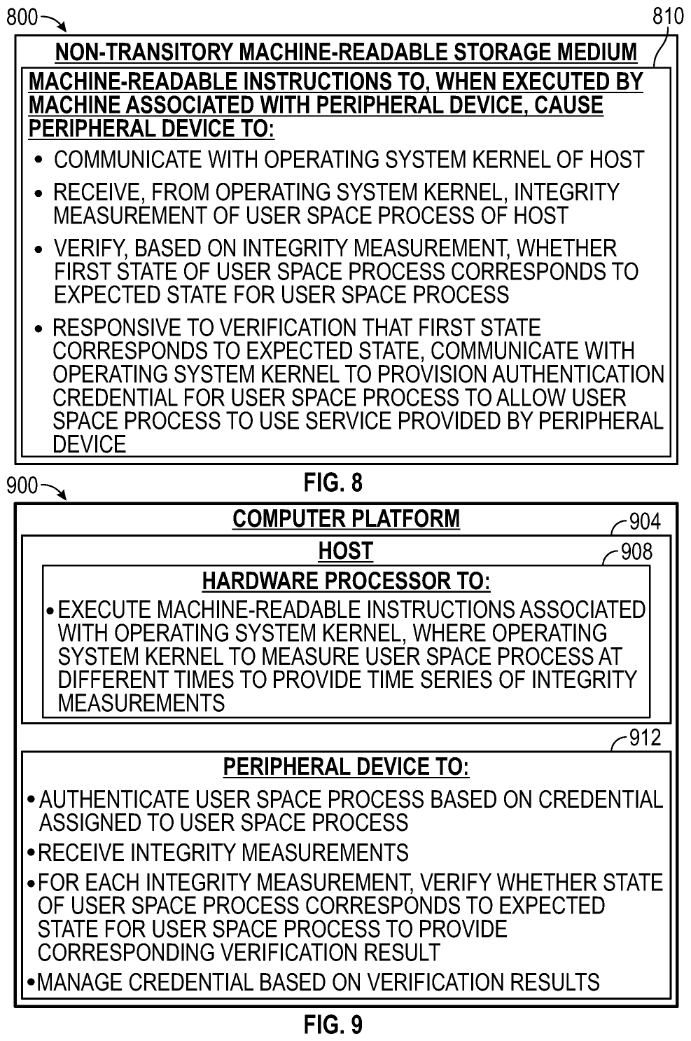

Referring to FIG. 8, in accordance with example implementations, a non-transitory machine-readable storage medium 800 stores machine-readable instructions 810. The machine-readable instructions, when executed by a peripheral device, cause the peripheral device to communicate with an operating system-based kernel of a host. In an example, the peripheral device may be a baseboard management controller. In another example, the peripheral device may be a graphics processing unit. In another example, the peripheral device may be a smart I/O peripheral device. In an example, communicating with the operating system-based kernel includes communicating with a helper agent of the kernel. In an example, the helper agent may correspond to a loadable kernel module (LKM). In another example, the helper agent may correspond to a kernel driver. In another example, the helper agent may correspond to an eBPF module. In another example, the helper agent may be an integrated part of the kernel core.

The instructions 810, when executed by the peripheral device, cause the peripheral device to receive, from an operating system kernel, an integrity measurement of a user space process of the host. In an example, the operating system kernel may be a LINUX kernel. In another example, the operating system kernel may be a WINDOWS NT kernel. In an example, the integrity measurement may correspond to a hash of in-memory content associated with the user space process. In an example, the in-memory content may be a runtime invariant content, which is not expected to change during runtime. In an example, the in-memory content may correspond to a text segment associated with the user space process. In an example, the integrity measurement may correspond to multiple invariant in-memory segments associated with the user space process, such as multiple text segments associated with the user space process. In an example, the integrity measurement may include a hash of in-memory content associated with the user space process in combination with time-invariant content from one or multiple libraries that are dynamically linked to the user space process. In an example, the integrity measurement may be a hash of in-memory content associated with the user space process along with data representing one or multiple attributes of the user space process other than in-memory content.

In an example, the integrity measurement may be an attribute of the user space process, other than a digest, or hash. In an example, an integrity measurement may be a process path of the user space process. In an example, an integrity measurement may be the name of an executable file corresponding to the user space process. In an example, an integrity measurement may be the name of an executable file associated with the user space process in addition to one or multiple command parameters passed to the user space process. In an example, an integrity measurement attribute may be a specific name of a particular environment variable. In example, an integrity measurement may be a specific name of an environment variable and a path associated with the environment variable. In an example, an integrity measurement may be an indicator of compromise associated with the user space process.

The instructions 810, when executed by the peripheral device, further cause the peripheral device to verify, based on the integrity measurement, whether a first state of the user space process corresponds to an expected state for the user space process. In an example, the verification may include determining whether an expected integrity measurement for the user space process corresponds to the integrity measurement received from the operating system kernel. In an example, the verification may include determining whether a runtime digest of in-memory content associated with the user space process matches an expected digest for the user space process. In an example, the verification may include determining whether the user space process is associated with an indicator of compromise. In an example, the verification may include determining whether an attribute of the user space process corresponds to an expected attribute for the user space process.

The instructions 810, when executed by the peripheral device, further cause the peripheral device to, responsive to verification that the first state corresponds to the expected state, communicate with the kernel to provision an authentication credential for the user space process to allow the user space process to use a service that is provided by the peripheral device. In an example, the authentication credential may be a token. In an example, the authentication credential may be a randomly-generated or pseudorandomly-generated number. In an example, the authentication credential may be part of a set of authentication credentials including an asymmetric cryptographic key pair and a digital certificate. In an example, the digital certificate may be an X.509 digital certificate. In an example, the authentication credential may be a set of authentication credentials including a user name and a password.

In an example, provisioning the authentication credential includes the peripheral device sending the authentication credential to the kernel using an encrypted communication channel between the peripheral device and the kernel. In an example, the service may be a management service. In an example, the service may be a management service to retrieve operating system events from the kernel. In an example, the service may provide a log of events detected by the peripheral device. In an example, the service may update at least one of system software or firmware. In an example, the service may be remotely-controlled. In an example, the user space process may be associated with an application or a service executed by the host.

Referring to FIG. 9, a computer platform 900 includes a host 904 and a peripheral device 912. In an example, the host 904 may associated with an operating system. In an example, the host 904 may provide a primary function of supporting an operating system and supporting user space processes. In an example, the peripheral device may be a baseboard management controller. In another example, the peripheral device may be a graphics processing unit. In another example, the peripheral device may be a smart I/O peripheral device.

The host 904 includes a hardware processor 908 to execute machine-readable instructions that are associated with an operating system kernel. In an example, the hardware processor 908 may include one or multiple CPU processing cores. In examples, the operating system kernel may be a WINDOWS NT kernel or a LINUX kernel. In an example, the instructions may correspond to a loadable kernel module (LKM). In another example, the instructions may correspond to a kernel driver. In another example, the instructions may correspond to an eBPF module. In another example, the instructions may be an integrated part of the kernel core.

The kernel measures a user space process at different times to provide a time series of integrity measurements. In an example, an integrity measurement may correspond to a hash of in-memory content associated with the user space process. In an example, the in-memory content may be content, which is not expected to change during runtime. In an example, the in-memory content may correspond to a text segment associated with the user space process. In an example, an integrity measurement may correspond to multiple invariant in-memory segments associated with the user space process, such as multiple text segments associated with the user space process. In an example, an integrity measurement may be a hash of in-memory content associated with the user space process along with data representing one or multiple attributes of the user space process other than in-memory content. In an example, the integrity measurement may include a hash of in-memory content associated with the user space process in combination with time-invariant content from one or multiple libraries that are dynamically linked to the user space process.

In an example, an integrity measurement may be an attribute of the user space process, other than a digest or hash. In an example, the attribute may be a process path of the user space process. In an example, an attribute may be the name of an executable file corresponding to the user space process. In an example, an attribute may be the name of an executable file associated with the user space process in addition to one or multiple command parameters passed to the user space process. In an example, an attribute may be a particular environment variable associated with the user space process. In an example, an attribute may indicate how a particular environment variable is used. In an example, an attribute may be a path associated with an environment variable. In an example, an attribute may be an indicator of compromise associated with the user space process.

The peripheral device 912 authenticates the user space process based on a credential that is assigned to the user space process. In an example, the credential may be a token. In an example, the credential may be a random number. In an example, the credential may be part of a set of credentials including an asymmetric cryptographic key pair and a digital certificate. In an example, the digital certificate may be an X.509 digital certificate. In an example, the credential may be a set of credentials including a user name and a password.

The peripheral device 912 receives the integrity measurements, and for each integrity measurement, the peripheral device 912 verifies whether a state of the user space process corresponds to an expected state for the user space process to provide a corresponding verification result. In an example, the verification may include determining whether an expected integrity measurement for the user space process corresponds to the integrity measurement received from the operating system kernel. In an example, the verification may include determining whether the user space process is associated with an indicator of compromise. In an example, the verification may include determining whether an attribute of the user space process corresponds to an expected attribute for the user space process.

The peripheral device 912 manages the credential based on the verification results. In an example, managing the credential includes provisioning the credential. In another example, managing the credential includes revoking the credential. In another example, managing the credential includes associating with the credential with one or multiple privileges.

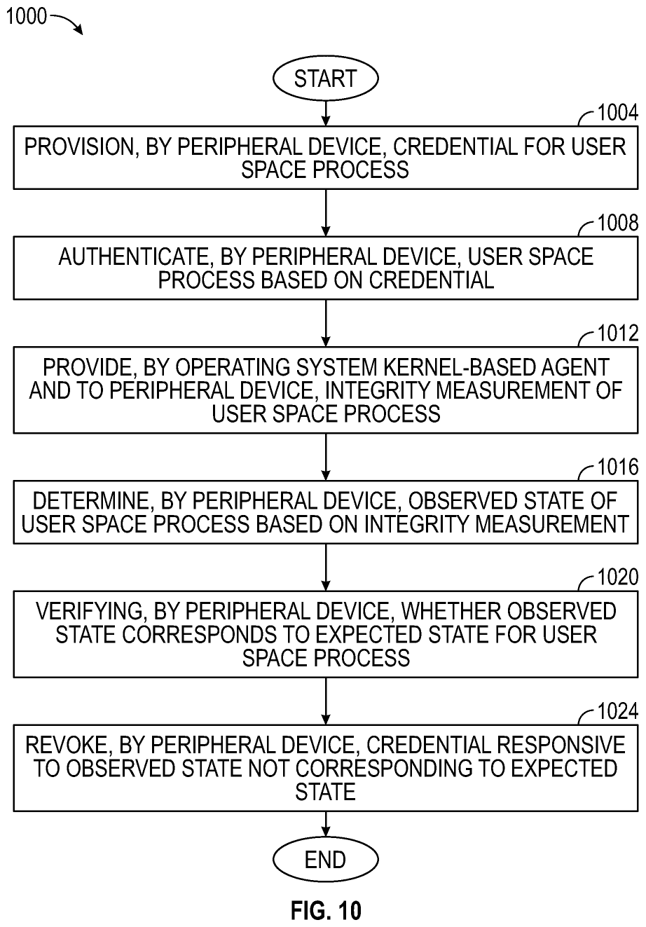

Referring to FIG. 10, a technique 1000 includes provisioning (block 1004), by a peripheral device, a credential for a user space process. In an example, provisioning the credential includes generating a token. In an example, provisioning the credential includes using a random number generator to generate a random number corresponding to the token. In another example, provisioning the credential includes using a pseudorandom number generator to generate a pseudorandom number corresponding to the token. In another example, provisioning the credential include generating an asymmetric cryptographic key pair and a digital certificate. In another example, provisioning the credential includes sending, by the peripheral device, the credential to an operating system kernel. In an example, provisioning the credential includes sending, by the operating system kernel, the credential to the user space process. In an example, provisioning the credential includes assigning one or multiple privileges to the credentials. In an example, provisioning the credential includes associated an integrity measurement with the credential.

The technique 1000 includes authenticating (block 1008), by the peripheral device, the user space process based on the credential. The technique 1000 includes providing (block 1012), by an operating system kernel-based agent and to the peripheral device, an integrity measurement of the user space process. In an example, the helper agent may correspond to an LKM. In another example, the helper agent may correspond to a kernel driver. In another example, the helper agent may correspond to an eBPF module. In another example, the helper agent may be an integrated part of the kernel core.

In an example, an integrity measurement may correspond to a hash of in-memory content associated with the user space process. In an example, the in-memory content may be content, which is not expected to change during runtime. In an example, the in-memory content may correspond to a text segment associated with the user space process. In an example, an integrity measurement may correspond to multiple invariant in-memory segments associated with the user space process, such as multiple text segments associated with the user space process.

In an example, an integrity measurement may be a digest, or hash, of in-memory content associated with the user space process along with data representing one or multiple attributes of the user space process other than in-memory content. In an example, the integrity measurement may include a hash of in-memory content associated with the user space process in combination with time-invariant content from one or multiple libraries that are dynamically linked to the user space process.

In another example, an integrity measurement may be an attribute of the user space process, other than a digest, or hash. In an example, an integrity measurement may be a process path of the user space process. In another example, an integrity measurement may be the name of an executable file that corresponds to the user space process. In another example, an integrity measurement may be the name of an executable file that is associated with the user space process in addition to one or multiple command parameters that are passed to the user space process. In an example, an attribute may be a particular environment variable associated with the user space process. In an example, an attribute may indicate how a particular environment variable is used. In an example, an attribute may be a path associated with an environment variable. In an example, an integrity measurement may be an indicator of compromise associated with the user space process.

The technique 1000 includes determining (block 1016), by the peripheral device, an observed state of the user space process based on the integrity measurement. In an example, determining the observed state may include determining a collection of one or multiple observed integrity measurements of the user space process, which are compared to a collection of one or multiple expected integrity measurements for the user space process for purposes of determining whether the observed integrity measurement(s) match the expected integrity measurement(s). More specifically, the technique 1000 includes verifying (block 1020), by the peripheral device, whether the observed state corresponds to an expected state for the user space process. In an example, determining whether the observed state corresponds to the expected state includes determining whether an expected digest for the user space process corresponds to a runtime digest for the user space process. In another example, determining whether the observed state corresponds to the expected state includes determining whether the user space process is associated with an indicator of compromise.

In an example, determining whether the observed state corresponds to the expected state includes determining whether a process path of the user space process corresponds to an expected process path for the user space process. In an example, determining whether the observed state corresponds to the expected state includes determining whether an executable file name corresponding to the user space process corresponds to an expected file name for the user space process. In an example, determining whether the observed state corresponds to the expected state includes determining whether command parameters corresponding to the user space process corresponds to expected command parameters for the user space process. In an example, determining whether the observed state corresponds to the expected state includes determining whether an extent of a segment of the user space process corresponds to expected extent for the segment.

In other examples, determining whether the observed state corresponds to the expected state includes determining whether the user space process is associated with a particular environment variable (e.g., an LD_PRELOAD environment variable or an LD_LIBRARY_PATH environment variable) and/or determining whether the particular environment variable is used in an expected way. In an example, determining whether the observed state corresponds to the expected state includes determining whether the user space process is associated with a particular environment variable and if so, determining whether the environment variable has a specific associated load path. In another example, determining whether the observed state corresponds to the expected state includes determining whether the user space process is associated with a particular environment variable and if so, verifying the load path associated with the environment variable to ensure the load path references a legitimate, or authorized, resource (e.g., an authorized library).

The technique 1000 includes revoking (block 1024) by the peripheral device, the credential responsive to the observed state not corresponding to the expected state. In an example, revoking the credential includes notifying, by the peripheral device, the operating system kernel-based agent about the revocation of the credential. In an example, the revoking includes the peripheral device logging the revocation. In an example, the revoking includes the peripheral device initiating a responsive action. In an example, the responsive action includes sending an alert message. In an example, the responsive action includes quarantining a computer platform from a network.

In accordance with example implementations, the peripheral device establishes a communication channel with the host. Establishing the communication channel includes authenticating, by the peripheral device, the user space process based on the credential. Among the potential advantages, credentials for user space processes may be securely managed by a peripheral device without human intervention and in a manner that allows credentials for untrustworthy user space processes to be revoked.

In accordance with example implementations, the peripheral device sends, to the kernel, a request for an updated integrity measurement of the user space process; and selectively revokes the credential based on a response to the request. Among the potential advantages, credentials for user space processes may be securely managed by a peripheral device without human intervention and in a manner that allows credentials for untrustworthy user space processes to be revoked.

In accordance with example implementations, the peripheral device receives the updated integrity measurement responsive to the request; and determines an updated state of the user space process based on the updated integrity measurement. The peripheral device verifies whether the updated state corresponds to the expected state. The peripheral device revokes the credential responsive to the updated state not corresponding to the expected state. Among the potential advantages, credentials for user space processes may be securely managed by a peripheral device without human intervention and in a manner that allows credentials for untrustworthy user space processes to be revoked.

In accordance with example implementations, the peripheral device, responsive to the updated integrity measurement not being received by the peripheral device within an expected time interval that is associated with the sending of the request, revokes the credential. Among the potential advantages, credentials for user space processes may be securely managed by a peripheral device without human intervention and in a manner that allows credentials for untrustworthy user space processes to be revoked.

In accordance with example implementations, the peripheral device, responsive to the updated integrity measurement not being received by the peripheral device within the expected time interval, revokes at least one other credential that is associated with at least one other user space process. Among the potential advantages, credentials for user space processes may be securely managed by a peripheral device without human intervention and in a manner that allows credentials for untrustworthy user space processes to be revoked.

In accordance with example implementations, the peripheral device sends nonces to the kernel at respective times according to a predetermined schedule. The peripheral device controls a validity of the credential responsive to the sending of the nonces. Among the potential advantages, credentials for user space processes may be securely managed by a peripheral device without human intervention and in a manner that allows credentials for untrustworthy user space processes to be revoked.

In accordance with example implementations, the peripheral device sends a given nonce. The kernel is expected to respond to the sending of the given nonce with an expected value that is derived by applying a predetermined function to the given nonce. The peripheral device receives, from the kernel, a second value responsive to the sending of the given nonce; and determines that the second value does not correspond to the expected value. The peripheral device revokes the credential responsive to the determination that the second value does not correspond to the expected value. Among the potential advantages, credentials for user space processes may be securely managed by a peripheral device without human intervention and in a manner that allows credentials for untrustworthy user space processes to be revoked.

In accordance with example implementations, the peripheral device sends a given nonce, and the kernel is expected to respond to the sending of the given nonce within a predetermined time interval. The peripheral device determines that the kernel failed to respond to the sending of the given nonce within the predetermined time interval. The peripheral device revokes the credential responsive to the determination that the kernel failed to respond to the sending of the given nonce within the predetermined time interval. Among the potential advantages, credentials for user space processes may be securely managed by a peripheral device without human intervention and in a manner that allows credentials for untrustworthy user space processes to be revoked.

In accordance with example implementations, the peripheral device includes a baseboard management controller, a smart input/output (I/O) peripheral or a graphics processing unit (GPU). Among the potential advantages, credentials for user space processes may be securely managed by a peripheral device without human intervention and in a manner that allows credentials for untrustworthy user space processes to be revoked.

In accordance with example implementations, an initial integrity measurement of the user space process is provided, by the operating system kernel, to the peripheral device. The peripheral device determines an expected state for the user space process based on the initial integrity measurement. Among the potential advantages, credentials for user space processes may be securely managed by a peripheral device without human intervention and in a manner that allows credentials for untrustworthy user space processes to be revoked.

In accordance with example implementations, the peripheral device is provisioned with a manifest that includes data representing an expected integrity measurement for the user space process. The peripheral device determines an expected state for the user space process based on the expected integrity measurement. Among the potential advantages, credentials for user space processes may be securely managed by a peripheral device without human intervention and in a manner that allows credentials for untrustworthy user space processes to be revoked.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

1. A non-transitory machine-readable storage medium that store machine-readable instructions to, when executed by a peripheral device, cause the peripheral device to:
communicate with an operating system-based kernel of a host;
receive, from an operating system kernel, an integrity measurement of a user space process of the host;
verify, based on the integrity measurement, whether a first state of the user space process corresponds to an expected state for the user space process; and
responsive to verification that the first state corresponds to the expected state, communicate with the kernel to provision an authentication credential for the user space process to allow the user space process to use a service provided by the peripheral device.

2. The storage medium of claim 1, wherein:
the instructions, when executed by a peripheral device, further cause the peripheral device to establish a communication channel with the host, wherein establishing the communication channel comprises authenticating, by the peripheral device, the user space process based on the credential.

3. The storage medium of claim 1, wherein the instructions, when executed by the peripheral device, further cause the peripheral device to:
send, to the kernel, a request for an updated integrity measurement of the user space process; and
selectively revoke the credential based on a response to the request.

4. The storage medium of claim 3, wherein the instructions, when executed by the peripheral device, further cause the peripheral device to:
receive the updated integrity measurement responsive to the request;
determine an updated state of the user space process based on the updated integrity measurement;
verify whether the updated state corresponds to the expected state; and
revoke the credential responsive to the updated state not corresponding to the expected state.

5. The storage medium of claim 3, wherein the instructions, when executed by the peripheral device, further cause the peripheral device to, responsive to the updated integrity measurement not being received by the peripheral device within an expected time interval associated with the sending of the request, revoke the credential.

6. The storage medium of claim 5, wherein the instructions, when executed by the peripheral device, further cause the peripheral device to, responsive to the updated integrity measurement not being received by the peripheral device within the expected time interval, revoke at least one other credential associated with at least one other user space process.

7. A computer platform comprising:
a host comprising a hardware processor to execute machine-readable instructions associated with an operating system kernel, wherein the kernel to measure a user space process at different times to provide a time series of integrity measurements; and
a peripheral device to:
authenticate the user space process based on a credential assigned to the user space process;
receive the integrity measurements;
for each integrity measurement of the integrity measurements, verify whether a state of the user space process corresponds to an expected state for the user space process to provide a corresponding verification result; and
manage the credential based on the verification results.

8. The computer platform of claim 7, wherein the peripheral device to further:
send nonces to the kernel at respective times according to a predetermined schedule; and
control a validity of the credential responsive to the sending of the nonces.

9. The computer platform of claim 8, wherein the peripheral device to further:
send a given nonce of the nonces, wherein the kernel is expected to respond to the sending of the given nonce with an expected value derived by applying a predetermined function to the given nonce;
receive, from the kernel, a second value responsive to the sending of the given nonce;
determine that the second value does not correspond to the expected value; and
revoke the credential responsive to the determination that the second value does not correspond to the expected value.

10. The computer platform of claim 8, wherein the peripheral device to further:
send a given nonce of the nonces, wherein the kernel is expected to respond to the sending of the given nonce within a predetermined time interval;
determine that the kernel failed to respond to the sending of the given nonce within the predetermined time interval; and
revoke the credential responsive to the determination that the kernel failed to respond to the sending of the given nonce within the predetermined time interval.

11. The computer platform of claim 7, wherein the peripheral device comprises a baseboard management controller, a smart input/output (I/O) peripheral or a graphics processing unit (GPU).

12. A method comprising:
provisioning, by a peripheral device, a credential for a user space process;
authenticating, by the peripheral device, the user space process based on the credential;
providing, by an operating system kernel-based agent and to the peripheral device, an integrity measurement of the user space process;
determining, by the peripheral device, an observed state of the user space process based on the integrity measurement;
verifying, by the peripheral device, whether the observed state corresponds to an expected state for the user space process; and
revoking, by the peripheral device, the credential responsive to the observed state not corresponding to the expected state.

13. The method of claim 12, further comprising:
providing, by the operating system kernel-based agent and to the peripheral device, an initial integrity measurement of the user space process; and
determining, by the peripheral device, the expected state based on the initial integrity measurement.

14. The method of claim 12, further comprising:
provisioning the peripheral device with a manifest comprising data representing an expected integrity measurement for the user space process; and
determining, by the peripheral device, the expected state based on the expected integrity measurement.

15. The method of claim 12, wherein verifying whether the observed state corresponds to the expected state comprises determining, by the peripheral device, whether a value corresponding to an attribute of the user space process other than a hash of in-memory content associated with the user space process is different from an expected value for the attribute.

16. The method of claim 15, wherein the attribute comprises at least one of a process path, a name of an executable file corresponding to the user space process and arguments passed in a call to the file, an environment variable, a size of an in-memory text segment associated with the user space process, or a permission associated with an in-memory text segment associated with the user space process.

17. The method of claim 12, wherein verifying whether the observed state corresponds to the expected state comprises determining, by the peripheral device, whether a measurement of an invariant content associated with a library dynamically linked to the user space process is different from an expected measurement of the invariant content for the user space process.

18. The method of claim 12, further comprising:
measuring, by the operating system kernel-based agent, memory content associated with the user space process and expected to be invariant; and
determining, by the operating system kernel-based agent, the integrity measurement based on a result of the measuring.

19. The method of claim 12, further comprising:
measuring, by the operating system kernel-based agent, content associated with a library dynamically linked to the user space process; and
determining, by the operating system kernel-based agent, the integrity measurement based on a result of the measuring.

20. The method of claim 12, wherein provisioning the credential comprises:
assigning, by the peripheral device, a permission to the credential; and
associating, by the peripheral device, the permission with the expected state.
